(19) United States
(12) Patent Application Publication
(10) Pub. No.: US 2017/0044290 A1
(43) Pub. Date: Feb. 16, 2017

(54) STABLE AND ION-CONDUCTIVE FLUOROPOLYMER-BASED ELECTROLYTES

(71) Applicants: MIDWEST ENERGY GROUP INC., Carbondale, IL (US); BOARD OF TRUSTEES OF SOUTHERN ILLINOIS UNIVERSITY ON BEHALF OF SOUTHERN ILLINOIS UNIVERSITY CARBONDA, Carbondale, IL (US)

(72) Inventors: Rong JIANG, Carbondale, IL (US); Yong GAO, Carbondale, IL (US)

(73) Assignee: Midwest Energy Group Inc., Carbondale, IL (US)

(21) Appl. No.: 15/306,019

(22) PCT Filed: Apr. 24, 2015
(86) PCT No.: PCT/US2015/027551

§ 371 Date: Oct. 21, 2016

Related U.S. Application Data
(60) Provisional application No. 62/108,335, filed on Jan. 27, 2015.
(60) Provisional application No. 61/985,825, filed on Apr. 29, 2014.

(51) Int. Cl. C08F 226/06; H01M 8/1039; H01M 8/103; C08F 214/26; C08F 114/18

(52) U.S. Cl. CPC C08F 226/06; C08F 214/262; C08F 114/185; H01M 8/103; H01M 8/1039; H01M 2008/1095

(57) ABSTRACT

Novel fluorocarbon polymers with a heteroaromatic group or a HPCA group are disclosed. A protonated fluoropolymer with a heteroaromatic group can be used as a cation-conductive electrolyte while an HPCA-based fluoropolymer encapsulating a H⁺ or Li⁺ can be employed as anion-transporting electrolyte.

### CROSS-REFERENCE TO RELATED APPLICATION

This application claims priority to U.S. Provisional Application Ser. No. 61/985,825 filed on Apr. 29, 2014 and U.S. Provisional Application Ser. No. 62/108,335 filed on Jan. 27, 2015, each of which is hereby incorporated by reference in its entirety.

### GOVERNMENTAL RIGHTS

This invention was made with government support under SBIR/STTR grants 1106630 and 0711652 awarded by the National Science Foundation. The government has certain rights in this invention.

### FIELD OF THE INVENTION

The present disclosure generally relates to novel fluoropolymer materials having (a) a heteropolycyclic alkane group as anion-conductive electrolytes, and (b) a protonated heteroaromatic group as cation-conductive materials, the use of the same in applications such as proton exchange membrane fuel cells (PEMFCs), alkaline membrane fuel cells (AMFCs), phosphoric acid fuel cells (PAFCs), methanol fuel cells, electrolytic cells and many other devices, and the methods to make the same.

### BACKGROUND OF THE INVENTION

Low or medium temperature fuel cells in general include PEMFCs, AMFCs, PAFCs and methanol fuel cells. Perfluorosulfonic acids (PFSAs) such as Nafion® and Aquivion® have been employed in PEMFCs and PAFCs: a solid PFSA membrane is used to separate reactants in anode and cathode and transport protons between two chambers; a PFSA aqueous solution is added to anode and cathode to improve their catalytic activities.

Typically, PEMFCs are operated at a temperature ranging from 60 to 80° C. At an elevated temperature (˜100-200° C.), humidity and start/stop cycling conditions cause the formation of peroxides-free radicals, which accelerates the chemical degradation of the PFSA polymer. It was reported that the PFSA membrane can last less than a few hundred hours when operated above 100° C. (Chem. Rev. 2007, 107, 3904).

Fuel cell automotive applications in general prefer to operate at a medium or high temperature (>100° C.). At 120° C., PFSAs have better ion conductivities than at 80° C. At an elevated temperature (e.g., 120° C.), a PEMFC is much less sensitive to carbon monoxide. Hydrogen fuels from a reformed hydrocarbon such as natural gas, gasoline or alcohols usually contain a small amount of carbon monoxide impurities that can poison the Pt catalysts in a fuel cell.

Past efforts have been directed to improve the durability of PFSAs at elevated temperatures (˜100-200° C.). Ishikawa (EP2190047A1) disclosed the adoption of CeO₂ as a peroxide decomposition catalyst to improve the lifespan of PFSAs. TiO₂ (J. Electrochem. Soc. 2005, 152, A1742), SiO₂, PTFE, imidazole, etc. were reported to be physically blended with Nafion® membranes to improve their high temperature stability and conductivity. Unfortunately, these additives can leak out of a solid membrane and potentially poison the Pt electro-catalysts in a fuel cell. For example, Yang et al. (J. Power Sources, 2001, 103, 1) reported that an imidazole-impregnated Nafion® membrane poisoned the Pt catalyst and the fuel cell was not able to generate any current. As a consequence, novel proton-conductive polymer electrolytes that can withstand an elevated temperature of 100-200° C. are urgently needed.

In an AMFC, an anion-conductive polymer membrane can be assembled between an anode and a cathode in a membrane electrode assembly. The membrane separates reductive and oxidative reactants at two electrodes and it is also responsible for transporting hydroxide anions from cathode to anode for charge balance. The ion conductivity of an alkaline-conductive polymer membrane is an important factor in the power density and efficiency of a fuel cell. A competitive advantage of alkaline membrane fuel cells is that electro-kinetics of oxygen reduction and fuel oxidation kinetics in an alkaline medium have shown enhanced kinetics in comparison with an acidic medium. As a result, non-precious metal electrode catalysts (e.g., Ni, Ag, Fe, Mn, Cr) can be utilized in AMFCs.

Presently, there appears to be no anion-conductive polymer membrane commercially available for AMFCs. Major challenges to the alkaline-conductive materials can be: (a) the long-term stability and (b) the ion conductivity of the membrane. Hydroxide anions are generally known to be strong nucleophiles that can attack the hydrocarbon structures of the polymer backbones and tertiary ammonium functionalities via nucleophilic substitution and elimination reactions leading to the destruction of the polymer membranes and thus the stability of alkaline-conductive materials can be a great concern.

As a result, there is an urgent need to develop stable and highly ion-conductive electrolyte polymers for fuel cell applications. In addition, novel ion-conductive electrolytes can find applications in metal-air batteries, electrolytic cells and numerous industrial processes, such as water treatment, hydrometallurgy, chemical and pharmaceutical separation.

The present disclosure provides a new coupling method that enables the synthesis of (a) novel fluorocarbon polymers comprising a heteroaromatic group, which in contact with an acid to be used as stable cation-conductive electrolytes; and (b) novel fluorocarbon polymers comprising a heteropolycyclic alkane (HPCA) that can encapsulate monovalent cations like proton and Li⁺ to be used as stable anion-conductive electrolytes. A heteroaromatic group or a HPCA is grafted to the side chain of a fluorocarbon polymer via a stable C—C covalent bond that is not acid and base labile.

### SUMMARY OF THE INVENTION

In one embodiment the present invention provides a fluorocarbon polymer comprising a plurality of RU(triattetra-zole) and optionally random or sequentially placed repeated units of tetrafluoroethylene (RU(TFE)), having the structure of (II):

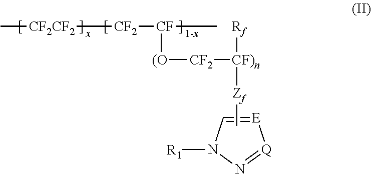

wherein, x is a number ranging from 0 to 0.99 and represents the mole fraction of RU(TFE) in the fluorocarbon polymer; 1−x is a number ranging from 1 to 0.01 and represents the mole fraction of RU(tria/tetra-zole) in the fluorocarbon polymer; —R_{f} is chosen from —F and —CF₃; n represents the number of the —OCF₂CR_{f}F— unit and is either 1 or 2; —Z_{f}— is selected from a group of a direct bond, —CF₂—, —CF₂CF₂—, and —OCF₂CF₂—; E and Q are chosen from C—R₂ and N; at least one of E and Q is N; R₁ and R₂ are H, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring.

Another embodiment of the present disclosure provides a fluorocarbon polymer comprising a plurality of RU(imidazole) and optionally random or sequentially placed repeated units of tetrafluoroethylene (RU(TFE)), having the structure of (IV):

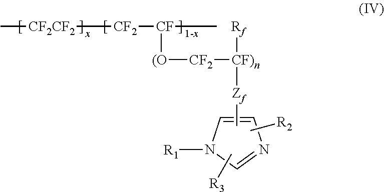

wherein, R₁, R₂ and R₃ are H, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring.

A third embodiment of the present invention provides a fluorocarbon polymer comprising a plurality of RU(aniline) and optionally random or sequentially placed repeated units of tetrafluoroethylene (RU(TFE)), having the structure of formula (VI):

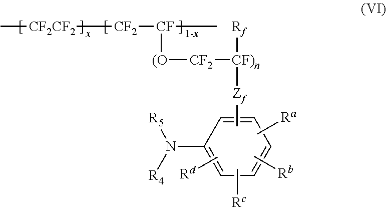

wherein, R^{a}, R^{b} and R^{c} are H, or F, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring; —R₄ and —R₅ are independently chosen from —H, —R′, —C(O)R′, —S(O)R′, and —S(O)₂R′, wherein R′ is a monovalent (C₁-C₆)hydrocarbon or a bivalent (C₁-C₆)hydrocarbon residue-two of which taken together can form a cycloalkyl or aromatic ring.

A further embodiment is a cation-conductive electrolyte comprising H⁺_{n′}X^{n′-} and a fluorocarbon polymer selected from formula (II), or (IV) or (VI), wherein n′ is an integer number chosen from 1, 2, 3, 4 and 5; X^{n′-} can be any negative-charged anion.

An embodiment of the present disclosure provides a fluorocarbon polymer comprising a plurality of RU(HPCA) and optionally random or sequentially placed repeated units of tetrafluoroethylene (RU(TFE)), having a structure of (VII):

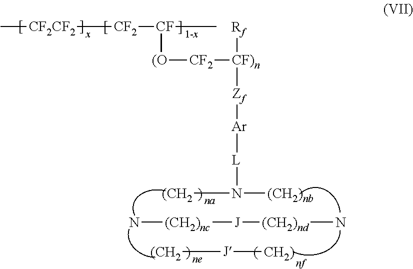

wherein, —Ar— is selected from a direct bond, and a di- or more substituted aromatic or heteroaromatic group; -L- is selected from a direct bond, —(CH₂)ₘ—, —(CH₂O)ₘ—, —(CH₂CH₂O)ₘ—, and —(CH₂CH₂NH)ₘ—, wherein n is an integer that ranges from 1 to 6; na, nb, nc, nd, ne, and nf are an integer number of either 2 or 3. -J- and -J′- are either —O—, or —NR″, wherein R″ is either H or a (C₁-C₆)hydrocarbon.

Another embodiment of the present disclosure provides a fluorocarbon polymer comprising a plurality of RU(HPCA) and optionally random or sequentially placed repeated units of tetrafluoroethylene (RU(TFE)), having a structure of (VIII):

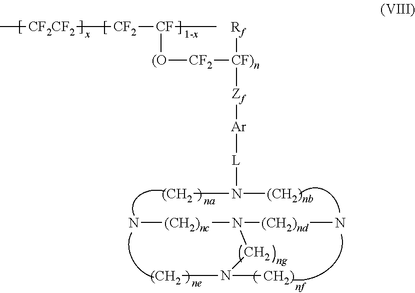

A further embodiment of the present disclosure provides a fluorocarbon polymer comprising a plurality of RU(HPCA) and optionally random or sequentially placed repeated units of tetrafluoroethylene (RU(TFE)), having a structure of (IX):

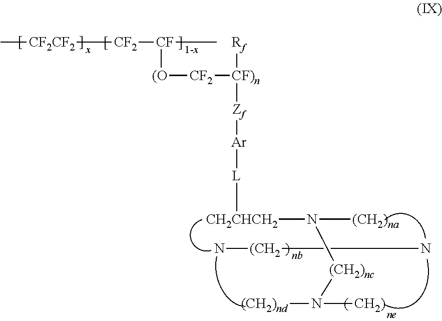

In yet another embodiment, an anion-conductive electrolyte comprising M⁺_{n′}X^{n′-} and a fluorocarbon polymer selected from formula (VII), or (VIII) or (IX), wherein n′ is an integer number chosen from 1, 2, 3, 4 and 5; X^{n′-} can be any negative-charged anion; M⁺ is a monovalent cation.

Other objects and features will be in part apparent and in part pointed out hereinafter.

### DETAILED DESCRIPTION OF THE INVENTION

Among the various aspects of the present disclosure is the provision of fluoropolymers having a heteroaromatic group or a heteropolycyclic alkane (HPCA) group.

(1) Fluorocarbon Polymers with Heteroaromatic Groups.

The first major portion of the present disclosure provides (a) a fluorocarbon polymer containing a triazole or a tetrazole ring, (b) a fluorocarbon polymer having an imidazole ring, and (c) and a fluorocarbon polymer having an aniline ring on its side chain.

### (a) A Fluorocarbon Polymer Containing Triazole or Tetrazole.

One embodiment of the present disclosure in this section provides a fluorocarbon polymer comprising a plurality of repeated units containing a triazole or tetrazole ring (RU(tria/tetra-zole)) of formula (I):

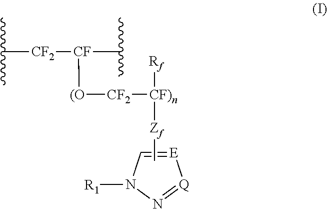

Wherein, wavy lines indicate the points of attachment to adjacent repeating units of the polymer; —R_{f} is chosen from —F and —CF₃; n represents the number of the —OCF₂CR_{f}F— unit and is either 1 or 2; —Z_{f}— is selected from a group of a direct bond, —CF₂—, —CF₂CF₂—, and —OCF₂CF₂—; E and Q are chosen from C—R₂ and N; at least one of E and Q is N; wherein R₁ and R₂ are H, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring.

Wherein a floating bond refers to a covalent bond that attaches the Z_{f} group to a carbon atom on the triazole or tetrazole ring provided that carbon atom has a total of four covalent bonds including this floating bond.

A C—C covalent bond between Z_{f} and a triazole or tetrazole ring is of particular importance to the long-term stability of the fluorocarbon polymer and the performance of a fuel cell device employing such solid polymeric electrolyte membranes. Many heteroaromatic compounds like imidazole, triazole and tetrazole are known for their strong affinity towards Pt (Chem. Rev. 2007, 107, 3904) and thus they can block the catalytic site of an electrocatalyst-leading to the deactivation of the fuel cell (J. Power Sources, 2001, 103, 1). As a result, a covalent bond between Z_{f} and the triazole or tetrazole ring can prevent the leaching of the heteroaromatic ring from the polymer.

The triazole or tetrazole ring in (I) contains at least three nitrogen atoms. In general, these heteroaromatic rings are regarded as Lewis bases, which can interact with a proton to form a N—H bond. Those skilled at the art can appreciate it that in some embodiments, more than one nitrogen atoms can be protonated.

In one aspect, an acid of H⁺_{n′}X^{n′-} can be blended with a RU(tria/tetra-zole)-containing fluorocarbon polymer at any ratio. n′ is an integer number chosen from 1, 2, 3, 4 and 5. X^{n′-} can be any negative-charged anion. Examples of such anions include Cl⁻, Br⁻, CO₃²⁻, HCO₃⁻, HSO₄⁻, SO₄²⁻, H₂PO₄⁻, HPO₄²⁻, PO₄³⁻, P₂O₇⁴⁻, and polyphosphates. Such an anion is loosely attracted by a protonated RU(tria/tetra-zole) unit. In one particular aspect, X^{n′-} can be covalently bonded to a hydrocarbon or a fluorocarbon material.

In (I), a protonated triazole or tetrazole serves as an ionized acid that transports protons. Such a structure can help avoid peroxide/free radical-based desulfurization frequently observed in a —CF₂—SO₂OH structure of Nafion® or other perfluorosulfonic acids at medium to high temperatures.

The present disclosure also covers a composite comprising an acid of H⁺_{n′}X^{n′-} and a fluorocarbon polymer of formula (I).

Another embodiment of the present disclosure provides a fluorocarbon polymer comprising a plurality of RU(tria/tetra-zole) and optionally random or sequentially placed repeated units of tetrafluoroethylene (RU(TFE)) of

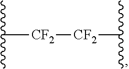

having the structure of formula (II):

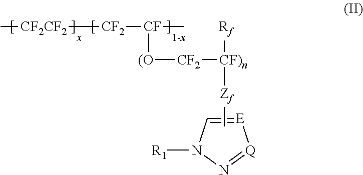

wherein, x is a number from 0 to 0.99 and represents the mole fraction of RU(TFE) in the fluorocarbon polymer. 1−x is a number ranging from 1 to 0.01 and represents the mole fraction of RU(tria/tetra-zole) in the fluorocarbon polymer. In one aspect, x ranges from 0.35 to 0.92, preferably from 0.65 to 0.92, from 0.78 to 0.92, from 0.84 to 0.88.

In a preferred embodiment of a fluorocarbon polymer with formula (II), wherein —R_{f} is —F; n=1; —Z_{f}— is a direct bond; wherein Q is N; E is C—R₂; wherein R₁ and R₂ are H, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring; preferably R₁ and R₂ are either H, or SO₃H. In the most preferable embodiment, R₁ and R₂ are both H.

In the second preferred embodiment of a fluorocarbon polymer with formula (II), wherein —R_{f} is —F; n=1; —Z_{f}— is a direct bond; wherein E is N; Q is C—R₂; R₁ and R₂ are H, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring; preferably R₁ and R₂ are H, or SO₃H. In the most preferable embodiment, R₁ and R₂ are both H.

In the third preferred embodiment of a fluorocarbon polymer with formula (II), wherein —R_{f} is —F; n=1; —Z_{f}— is either —CF₂— or —CF₂CF₂—; E is N; Q is C—R₂; R₁ and R₂ are H, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring; preferably R₁ and R₂ are either H, or SO₃H. In the most preferable embodiment, R₁ and R₂ are both H.

In the fourth preferred embodiment of a fluorocarbon polymer with formula (II), wherein —R_{f} is —F; n=1; —Z_{f}— is either —CF₂— or —CF₂CF₂—; Q is N; E is C—R₂; R₁ and R₂ are H, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring or a direct bond; preferably R₁ and R₂ are either H, or SO₃H. In the most preferable embodiment, R₁ and R₂ are both H.

In the fifth preferred embodiment of a fluorocarbon polymer with formula (II), wherein —R_{f} is —CF₃; n=1 or 2; —Z_{f}— is —OCF₂CF₂—; E is N; Q is C—R₂; wherein R₁ and R₂ are H, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring; preferably R₁ and R₂ are either H, or SO₃H. In the most preferable embodiment, R₁ and R₂ are both H.

In the sixth preferred embodiment of a fluorocarbon polymer with formula (II), wherein —R_{f} is —CF₃; n=1 or 2; —Z_{f}— is —OCF₂CF₂—; Q is N; E is C—R₂; R₁ and R₂ are H, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring; preferably R₁ and R₂ are either H, or SO₃H. In the most preferable embodiment, R₁ and R₂ are both H.

In yet another embodiment, the fluorocarbon polymer of (II) can have other repeated units of fluorocarbon group.

In an aspect, an acid of H⁺_{n′}X^{n′-} can be blended with a fluorocarbon polymer of formula (II) at any ratio. n′ is an integer number chosen from 1, 2, 3, 4 and 5. X^{n′-} can be any negative-charged anion. Examples of such anions include Cl⁻, Br⁻, CO₃²⁻, HCO₃⁻, HSO₄⁻, SO₄²⁻, H₂PO₄⁻, HPO₄²⁻, PO₄³⁻, P₂O₇⁴⁻, and polyphosphates. Such an anion is loosely attracted by a protonated RU(tria/tetra-zole) unit. In one particular aspect, X^{n′-} can be covalently bonded to a hydrocarbon or a fluorocarbon material.

The present disclosure also provides a composite comprising H⁺_{n′}X^{n′-} and a fluorocarbon polymer of formula (II); the concentration of H⁺_{n′}X^{n′-} ranges from 4 to 70 wt %, preferably from 4 to 40 wt %, and most preferably from 4 to 20 wt %, by weight of the composite.

### (b) A Fluorocarbon Polymer Containing Imidazole.

An embodiment of the present disclosure in this section provides a fluorocarbon polymer comprising a plurality of repeated units containing an imidazole ring (RU(imidazole)) of formula (III):

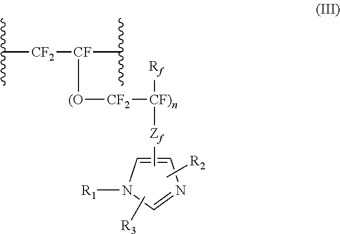

wherein wavy lines indicate the points of attachment to adjacent repeating units of the polymer; —R_{f} is chosen from —F and —CF₃; n represents the number of the —OCF₂CR_{f}F— unit and is either 1 or 2; —Z_{f}— is selected from a group of a direct bond, —CF₂—, —CF₂CF₂—, and —OCF₂CF₂—; R₁, R₂ and R₃ are H, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring.

Wherein a floating bond refers to a covalent bond that attaches the Z_{f} group, or R₂, or R₃ to a carbon atom of the imidazole ring provided that carbon atom has a total of four covalent bonds including this floating bond.

In one aspect, an acid of H⁺_{n′}X^{n′-} can be blended with a RU(imidazole) fluorocarbon polymer at any ratio. n′ is an integer number chosen from 1, 2, 3, 4 and 5. X^{n′-} can be any negative-charged anion. Examples of such anions include Cl⁻, Br⁻, CO₃²⁻, HCO₃₋, HSO₄₋, SO₄²⁻, H₂PO₄⁻, HPO₄²⁻, PO₄³⁻, P₂O₇⁴⁻, and polyphosphates. Such an anion is loosely attracted by a protonated RU(imidazole) unit. In one particular aspect, X^{n′-} can be covalently bonded to a hydrocarbon or a fluorocarbon material.

The present disclosure also covers a composite comprising H⁺_{n′}X^{n′-} and a fluorocarbon polymer of formula (III); the concentration of H⁺_{n′}X^{n′-} ranges from 4 to 70 wt %, preferably from 4 to 40 wt %, and most preferably from 4 to 20 wt %, by weight of the composite.

Another embodiment of the present disclosure provides a fluorocarbon polymer comprising a plurality of RU(imidazole) and optionally random or sequentially placed repeated units of tetrafluoroethylene (RU(TFE)) of

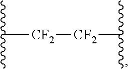

having the structure of formula (IV):

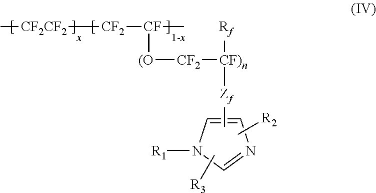

wherein x is a number from 0 to 0.99 and represents the mole fraction of RU(TFE) in the fluorocarbon polymer. 1−x is a number ranging from 1 to 0.01 and represents the mole fraction of RU(imidazole) in the fluorocarbon polymer. In one aspect, x ranges from 0.35 to 0.92, preferably from 0.65 to 0.92, from 0.78 to 0.92, from 0.84 to 0.88.

In a preferred embodiment of a fluorocarbon polymer with formula (IV), wherein —R_{f} is —F; n=1; —Z_{f}— is a direct bond; R₁, R₂ and R₃ are H, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring, preferably R₁, R₂ and R₃ are either H, or SO₃H. In the most preferable embodiment, R₁, R₂ and R₃ are all H.

In another preferred embodiment of a fluorocarbon polymer with formula (IV), wherein —R_{f} is —F; n=1; —Z_{f}— is either —CF₂— or —CF₂CF₂—; R₁, R₂ and R₃ are H, or SO₃H, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring, preferably R₁, R₂ and R₃ are either H, or SO₃H. In the most preferable embodiment, R₁, R₂ and R₃ are all H.

In the final preferred embodiment of a fluorocarbon polymer with formula (IV), wherein —R_{f} is —CF₃; n=1 or 2; —Z_{f}— is —OCF₂CF₂—; R₁, R₂ and R₃ are H, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring or a direct bond; preferably R₁, R₂ and R₃ are either H, or SO₃H. In the most preferable embodiment, R₁, R₂ and R₃ are all H.

In an aspect, an acid of H⁺_{n′}X^{n′-} can be blended with a fluorocarbon polymer with formula (IV) at any ratio to provide protons. n′ is an integer number chosen from 1, 2, 3, 4 and 5. X^{n′-} can be any negative-charged anion. Examples of such anions include Cl⁻, Br⁻, CO₃²⁻, HCO₃₋, HSO₄₋, SO₄²⁻, H₂PO₄₋, HPO₄²⁻, PO₄³⁻, P₂O₇⁴⁻, and polyphosphates. Such an anion is loosely attracted by a protonated RU(imidazole) unit. In one particular aspect, X^{n′-} can be covalently bonded to a hydrocarbon or a fluorocarbon material.

The present disclosure also provides a composite comprising H⁺_{n′}X^{n′-} and a fluorocarbon polymer of formula (IV); the concentration of H⁺_{n′}X^{n′-} ranges from 4 to 70 wt %, preferably from 4 to 40 wt %, and most preferably from 4 to 20 wt %, by weight of the composite.

### (c) A Fluorocarbon Polymer Containing Aniline.

An embodiment of the present disclosure in this section provides a fluorocarbon polymer comprising a plurality of repeated units containing an aniline ring (RU(aniline)) of formula (V):

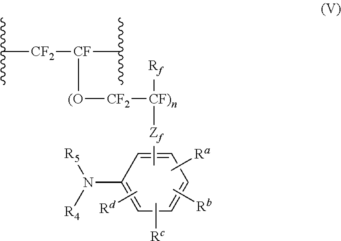

wherein wavy lines indicate the points of attachment to adjacent repeating units of the polymer; —R_{f} is chosen from —F and —CF₃; n represents the number of the —OCF₂CR_{f}F— unit and is either 1 or 2; —Z_{f}— is selected from a group of a direct bond, —CF₂—, —CF₂CF₂—, and —OCF₂CF₂—; R^{a}, R^{b} and R^{c} are H, or F, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring; preferably R^{a}, R^{b} and R^{c} are either F or CF₃, and most preferably R^{a}, R^{b} and R^{c} are all F.

Wherein —R₄ and —R₅ are independently chosen from —H, —R′, —C(O)R′, —S(O)R′, and —S(O)₂R′, wherein R′ is a monovalent (C₁-C₆)hydrocarbon or a bivalent (C₁-C₆)hydrocarbon residue-two of which taken together can form a cycloalkyl or aromatic ring. Preferably, —R₄ and —R₅ are either —H or —CH₃; and most preferably —R₄ and —R₅ are both H.

Wherein a floating bond refers to a covalent bond that attaches the Z_{f}, or R^{a}, or R^{b}, or R^{c} group to a carbon atom on the phenyl ring provided that carbon atom has a total of four covalent bonds including this floating bond.

Another embodiment of the present disclosure provides a fluorocarbon polymer comprising a plurality of RU(aniline) and optionally random or sequentially placed repeated units of tetrafluoroethylene (RU(TFE)) of

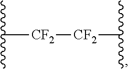

having the structure of formula (VI):

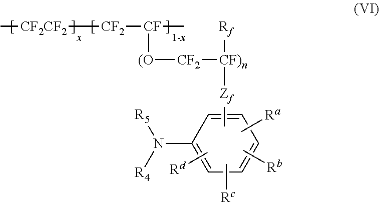

wherein x is a number from 0 to 0.99 and represents the mole fraction of RU(TFE) in the fluorocarbon polymer; 1−x is a number ranging from 1 to 0.01 and represents the mole fraction of RU(aniline) in the fluorocarbon polymer. In one aspect, x ranges from 0.35 to 0.92, preferably from 0.65 to 0.92, from 0.78 to 0.92, from 0.84 to 0.88.

In a preferred embodiment of a fluorocarbon polymer of formula (VI), wherein —R_{f} is —F; n=1; —Z_{f}— is a direct bond; R^{a}, R^{b} and R^{c} are H, or F, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring or a direct bond; preferably R^{a}, R^{b} and R^{c} are either F or CF₃, and most preferably R^{a}, R^{b} and R^{c} are F; wherein —R₄ and —R₅ are independently chosen from —H, —R′, —C(O)R′, —S(O)R′, and —S(O)₂R′, wherein R′ is a monovalent (C₁-C₆)hydrocarbon or a bivalent (C₁-C₆)hydrocarbon residue-two of which taken together can form a cycloalkyl or aromatic ring. Preferably, —R₄ and —R₅ are either —H or —CH₃; and most preferably —R₄ and —R₅ are both H.

In another preferred embodiment of a fluorocarbon polymer of formula (VI), wherein —R_{f} is —F; n=1; —Z_{f}— is either —CF₂— or —CF₂CF₂—; R^{a}, R^{b} and R^{c} are H, or F, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring or a direct bond; preferably R^{a}, R^{b} and R^{c} are either F or CF₃, and most preferably R^{a}, R^{b} and R^{c} are F; wherein —R₄ and —R₅ are independently chosen from —H, —R′, —C(O)R′, —S(O)R′, and —S(O)₂R′, wherein R′ is a monovalent (C₁-C₆)hydrocarbon or a bivalent (C₁-C₆)hydrocarbon residue-two of which taken together can form a cycloalkyl or aromatic ring. Preferably, —R₄ and —R₅ are either —H or —CH₃; and most preferably —R₃ and —R₄ are both H.

In the final preferred embodiment of a fluorocarbon polymer with formula (VI), wherein —R_{f} is —CF₃; n=1 or 2; —Z_{f}— is —OCF₂CF₂—; R^{a}, R^{b} and R^{c} are H, or F, or SO₃H, or NO₂, or CN, or a monovalent (C₁-C₆)hydrocarbon or a bivalent (C₁-C₆)hydrocarbon residue-two of which taken together can form a cycloalkyl or aromatic ring, or a monovalent (C₁-C₆)fluorocarbon, or a bivalent (C₁-C₆)fluorocarbon residue-two of which taken together can form a cyclofluoroalkyl or a fluorinated aromatic ring or a direct bond; preferably R^{a}, R^{b} and R^{c} are either F or CF₃, and most preferably R^{a}, R^{b} and R^{c} are F; wherein —R₄ and —R₅ are independently chosen from —H, —R′, —C(O)R′, —S(O)R′, and —S(O)₂R′, wherein R′ is a monovalent (C₁-C₆)hydrocarbon or a bivalent (C₁-C₆)hydrocarbon residue-two of which taken together can form a cycloalkyl or aromatic ring. Preferably, —R₄ and —R₅ are either —H or —CH₃; and most preferably —R₄ and —R₅ are both H.

In one aspect, an acid of H⁺_{n′}X^{n′-} can be blended with a RU(aniline) fluorocarbon polymer of formula (VI) at any ratio. n′ is an integer number chosen from 1, 2, 3, 4 and 5. X^{n′-} can be any negative-charged anion. Examples of such anions include Cl⁻, Br, CO₃²⁻, HCO₃₋, HSO₄₋, SO₄²⁻, H₂PO₄⁻, HPO₄²⁻, PO₄³⁻, P₂O₇⁴⁻, and polyphosphates. Such an anion is loosely attracted by a protonated RU(imidazole) unit. In one particular aspect, X^{n′-} can be covalently bonded to a hydrocarbon or a fluorocarbon material.

The present disclosure also covers a composite comprising H⁺_{n′}X^{n′-} and a fluorocarbon polymer of formula (VI); the concentration of H⁺_{n′}X^{n′-} ranges from 4 to 70 wt %, preferably from 4 to 40 wt %, and most preferably from 4 to 20 wt %, by weight of the composite.

(2) Fluorocarbon Polymers with Heteropolycyclic Alkane (HPCA) Groups.

A second major portion of the present disclosure provides HPCA-containing fluorocarbon polymers as highly stable and anion-conductive materials.

An embodiment of the present disclosure provides a fluorocarbon polymer comprising a plurality of RU(HPCA) and optionally random or sequentially placed repeated units of tetrafluoroethylene (RU(TFE)) of

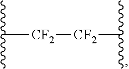

having a structure of (VII):

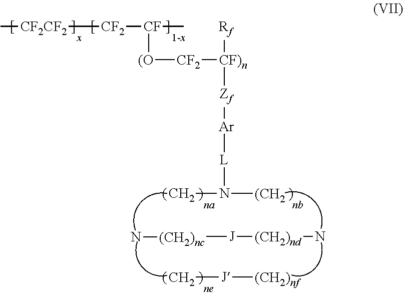

wherein x is a number from 0 to 0.99 and represents the mole fraction of RU(TFE) in the fluorocarbon polymer. 1−x is a number ranging from 1 to 0.01 and represents the mole fraction of RU(HPCA) in the fluorocarbon polymer. In one aspect, x ranges from 0.35 to 0.92, preferably from 0.65 to 0.92, from 0.78 to 0.92, from 0.84 to 0.88.

Wherein —R_{f} is either —F or —CF₃; n is an integer number of either 1 or 2 and it represents the number of the repeating unit of —OCF₂CFR_{f}—. —Z_{f}— is selected from a group of a direct bond, —CF₂—, —CF₂CF₂—, and —OCF₂CF₂—.

—Ar— is selected from a direct bond, and a di- or higher substituted aromatic or heteroaromatic group having a structure selected from the following:

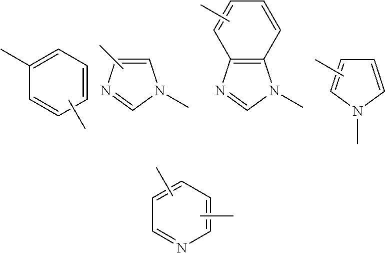

wherein a floating bond refers to a covalent bond that attaches to Z_{f} or A group to any carbon atom on an aromatic ring provided that carbon atom has a total of four covalent bonds; -L- is selected from a direct bond, —(CH₂)ₘ—, —(CH₂O)ₘ—, —(CH₂CH₂O)ₘ—, and —(CH₂CH₂NH)ₘ—, wherein n is an integer that ranges from 1 to 6.

Wherein na, nb, nc, nd, ne, and nf are an integer number of either 2 or 3; -J- and -J′- are either —O—, or —NR″; wherein R″ is either H or a (C₁-C₆)hydrocarbon.

For illustration purposes, curved lines or arc lines regardless of shapes and lengths, and straight lines regardless of direction and lengths are used herein to represent covalent bonds. Wavy lines indicate the points of attachment to adjacent repeating units of the polymer.

Another embodiment of the present disclosure provides a fluorocarbon polymer comprising a plurality of RU(HPCA) and optionally random or sequentially placed repeated units of tetrafluoroethylene (RU(TFE)) of

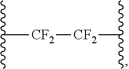

having a structure of (VIII):

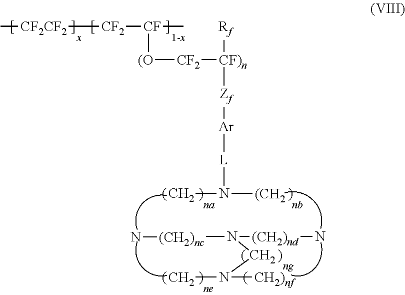

wherein x is a number from 0 to 0.99 and represents the mole fraction of RU(TFE) in the fluorocarbon polymer. 1−x is a number ranging from 1 to 0.01 and represents the mole fraction of RU(HPCA) in the fluorocarbon polymer. In one aspect, x ranges from 0.35 to 0.92, preferably from 0.65 to 0.92, from 0.78 to 0.92, from 0.84 to 0.88.

Wherein —R_{f} is either —F or —CF₃; n is an integer number of either 1 or 2 and it represents the number of the repeating unit of —OCF₂CFR_{f}—. —Z_{f}— is selected from a group of a direct bond, —CF₂—, —CF₂CF₂—, and —OCF₂CF₂—.

—Ar— is selected from a direct bond, and a di- or higher substituted aromatic or heteroaromatic group having a structure selected from the following:

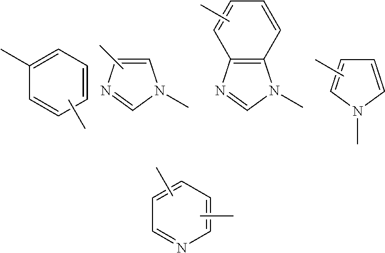

wherein a floating bond refers to a covalent bond that attaches to Z_{f} or A group to any carbon atom on an aromatic ring provided that carbon atom has a total of four covalent bonds. -L- is selected from a direct bond, —(CH₂)ₘ—, —(CH₂O)ₘ—, —(CH₂CH₂O)ₘ—, and —(CH₂CH₂NH)ₘ—, wherein n is an integer that ranges from 1 to 6, and wherein na, nb, nc, nd, ne, nf and ng are an integer number of either 2 or 3.

A final embodiment of the present disclosure provides a fluorocarbon polymer comprising a plurality of RU(HPCA) and optionally random or sequentially placed repeated units of tetrafluoroethylene (RU(TFE)) of

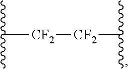

having a structure of (IX):

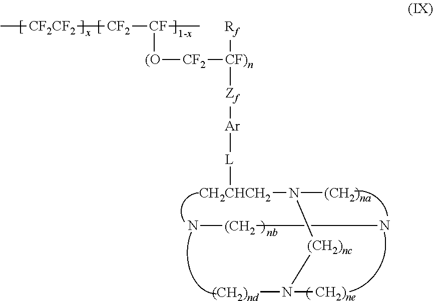

wherein x is a number from 0 to 0.99 and represents the mole fraction of RU(TFE) in the fluorocarbon polymer. 1−x is a number ranging from 1 to 0.01 and represents the mole fraction of RU(HPCA) in the fluorocarbon polymer. In one aspect, x ranges from 0.35 to 0.92, preferably from 0.65 to 0.92, from 0.78 to 0.92, from 0.84 to 0.88.

Wherein —R_{f} is either —F or —CF₃; n is an integer number of either 1 or 2 and it represents the number of the repeating unit of —OCF₂CFR_{f}—. —Z_{f}— is selected from a group of a direct bond, —CF₂—, —CF₂CF₂—, and —OCF₂CF₂—.

—Ar— is selected from a direct bond, and a di- or higher substituted aromatic or heteroaromatic group having a structure selected from the following:

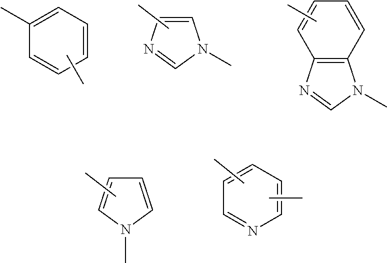

wherein a floating bond refers to a covalent bond that attaches to Z_{f} or A group to any carbon atom on an aromatic ring provided that carbon atom has a total of four covalent bonds. -L- is selected from a direct bond, —(CH₂)ₘ—, —(CH₂O)ₘ—, —(CH₂CH₂O)ₘ—, and —(CH₂CH₂NH)ₘ—, wherein n is an integer that ranges from 1 to 6, and wherein na, nb, nc, nd, and ne are an integer number of either 2 or 3.

The present disclosure also covers an HPCA composite comprising M⁺_{n′}Y^{n′-} and an HPCA fluorocarbon polymer of formula (VII) or (VIII) or (IX). Wherein M⁺ is H⁺, Na⁺, Li⁺, K⁺ or NH₄⁺ while the counter-anion Y^{n′-} is any anion and n′ is an integer number ranging from 1 to 5.

In a preferred embodiment of a fluorocarbon polymer with a formula selected from (VII), (VIII) and (IX), wherein —R_{f} is —F; n=1; —Z_{f}— is a direct bond; —Ar— is selected from

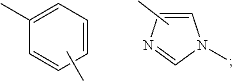

-L- is either a direct bond or —CH₂—. Wherein in formula (VII), na, nb, nc, nd, ne, and nf are all 2; -J- and -J′- both are —NH—; wherein in formula (VIII), na, nb, nc and nd are 2; ne, ng and nf are all 3; wherein in formula (IX), na, nb, nc, nd, and ne are all 3.

In another preferred embodiment of a fluorocarbon polymer with a formula selected from (VII), (VIII) and (IX), wherein —R_{f} is —F; n=1; —Z_{f}— is either —CF₂— or —CF₂CF₂—; —Ar— is selected from

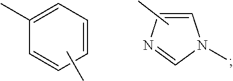

-L- is either a direct bond or —CH₂—. Wherein in formula (VII), na, nb, nc, nd, ne, and nf are all 2; -J- and -J′- both are —NH—; wherein in formula (VIII), na, nb, nc and nd are 2; ne, ng and nf are all 3; wherein in formula (IX), na, nb, nc, nd, and ne are all 3.

In yet another preferred embodiment of a fluorocarbon polymer with a formula selected from (VII), (VIII) and (IX), wherein —R_{f} is —CF₃; n=1 or 2; —Z_{f}— is —OCF₂CF₂—; —Ar— is selected from

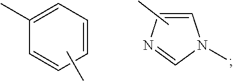

-L- is either a direct bond or —CH₂—. Wherein in formula (VII), na, nb, nc, nd, ne, and nf are all 2; -J- and -J′- both are —NH—; wherein in formula (VIII), na, nb, nc and nd are 2; ne, ng and nf are all 3; wherein in formula (IX), na, nb, nc, nd, and ne are all 3.

### (3) Fluorocarbon Polymer-Based Electrolytes and Devices.

An electrolyte is a substance having electrically-charged ions and ions can move to either a negative or positive electrode in an electric field. According to ASTM D1193-91 specifications, the ion conductivity of purified type I water at 25° C. is 5.6×10⁻⁶ S/m and type I purified water is not deemed as an ion-conductive material. Ion-conductive electrolytes herein are considered to have an ion conductivity larger than 5.6×10⁻⁶ S/m at 25° C. For practical applications in an electric device like a fuel cell or a metal-air battery, the ion conductivity of an ion-conductive electrolyte is typically at or larger than 1.0×10⁻⁵ S/m, at or above 1.0×10⁻⁴ S/m, at or preferably over 1.0×10⁻³ S/m, or most preferably at or larger than 1.0×10⁻² S/m at 25° C. Some measurement conditions used in an ion conductivity test may have effects on the ion conductivity of the test material, for example, the CO₂ concentration in the air and the water content in the test environment. The present disclosure covers a CO₂ volume composition ranging from 0.010 v/v % to 100 v/v %, preferably at 0.035 v/v % of the earth atmosphere CO₂ concentration. The water content in the test environment can range from a relative humidity of 1% to 100% or with the test material completely submerged in water, preferably under 100% relative humidity. Those skilled in the art will appreciate the variation of the ion conductivity measurement conditions.

In one embodiment, the present invention provides an cation-conductive electrolyte comprising an acid of H⁺_{n′}X^{n′-} and a fluorocarbon polymer with a formula chosen from formulas (I)-(VI) at any ratio. n′ is an integer number chosen from 1, 2, 3, 4 and 5. X^{n′-} can be any negative-charged anion. Examples of such anions include Cl⁻, Br, CO₃²⁻, HCO₃₋, HSO₄₋, SO₄²⁻, H₂PO₄₋, HPO₄²⁻, PO₄³⁻, P₂O₇⁴⁻, and polyphosphates. Such an anion is loosely attracted by a protonated heteroaromatic unit. In one particular aspect, X^{n′-} can be covalently bonded to a hydrocarbon or a fluorocarbon material.

In a preferred embodiment, H⁺_{n′}X^{n′-} is selected from H₂SO₄ and H₃PO₄, and the concentration of H⁺_{n′}X^{n′-} ranges from 4 to 70 wt %, preferably from 4 to 40 wt %, and most preferably from 4 to 20 wt %, by weight of the electrolyte composite.

In one aspect, a support can be added to the fluoropolymer electrolyte. Such a support can be a solid, or a liquid, or a gel. A solid support can be a poly(tetrafluoroethylene) film. The solid membrane displays the desirable properties and the membrane thickness can be from 1 micron to 200 microns, including all values of 1 micron and ranges therebetween. Examples of a liquid support material include water, sea water, ethanol, methanol, acetonitrile, thionyl chloride, dimethyl sulfoxide, dimethylformamide, and ionic liquids. A liquid support material is a material at a liquid state at 25° C. The liquid support material may or may not conduct ions. A gel support is a material at a gel state at 25° C. The gel support material may or may not conduct ions.

In a preferred aspect, the support can be expanded poly(tetrafluoroethylene) (PTFE) films. The use of a PTFE support can enhance the mechanic strength of the ion-exchange fluorocarbon polymer and reduce the overall cost of the ion-conductive composite membranes.

The density as well as the thickness of the PTFE support are of importance to the mechanic properties and ion conductivity of the composite membranes. The PTFE film supports in general need to have a polymer density ranging from 0.3 g/cm³ to 1.8 g/cm³, preferably from 0.3 g/cm³ to 1.2 g/cm³, and most preferably from 0.3 g/cm³ to 1.0 g/cm³. The thickness of the PTFE support can range from 20 microns to 180 microns, preferably from 20 microns to 150 microns, from 20 microns to 100 microns, and most preferably from 20 microns to 80 microns.

In another preferred aspect, the support is a metal-organic framework (MOF). The electrolyte is comprised of MOF and a fluorocarbon polymer comprising a heteroaromatic group or a HPCA. MOFs are compounds consisting of metal ions or clusters coordinated to often rigid organic molecules to form one-, two-, or three-dimensional structures that can be porous. An example of MOFs is porous Zn-aminotriazolato-oxalate with a chemical formula of Zn₂(C₂O₄)(C₂N₄H₃)₂(H₂O)_{0.5} (Chem. Commun. 2009, 5230). Depending upon the particular embodiment, the fluorocarbon polymer may be conjugated to the MOF by a variety of chemical bonds including, but not limited to, covalent bonding, non-covalent bonding, dative bonding, ionic bonding, hydrogen bonding, metallic bonding, or van der Waals bonding. An example is that an imidazole ring or a triazole ring of the fluorocarbon polymer can be part of the MOF framework structure.

In yet another preferred embodiment, the support can be a metal salt such as phosphotungstic acid, heteropolyacid, silicotungstic acid, zirconium hydrogen phosphate, zirconia, and zirconium hydrogen sulfate.

In a PEMFC or PAFC or methanol fuel cell, a cation-conductive membrane transports proton from anode to cathode while being impermeable to gaseous and liquid fuels. It is highly desirable that an ion-exchange membrane can be: (a) low hydrogen, methanol, and other liquid fuel crossover; (b) mechanically strong and do not tear or fracture under fuel cell operations; (c) swelling less than 20% of original membrane thickness is ideal; and (d) proton conductivity of from 1.0 mS/cm to 500 mS/cm is desirable. The higher conductivity, the better.

In particular, the mechanical properties of a solid membrane used in a fuel cell is of importance for its applications, especially at an elevated temperature, Membrane creep and microcrack fracture can lead to pinholes in a membrane and thus give rise to reactant gas crossover.

In one embodiment, the ion-conductive solid membrane has the maximum tensile in the machine direction for sheet processing (MD) or the maximum tensile strength in the transverse direction (TD) vertical to the MD direction both greater than 20 MPa under 50% relative humidity at 25° C.

In another aspect, the cation-conductive solid membrane has the maximum tensile strengths in both MD and TD of 25 MPa or greater under 50% relative humidity at 25° C.

In yet another embodiment, the cation-conductive solid membrane has the maximum tensile strengths in both MD and TD of 30 MPa or greater under 50% relative humidity at 25° C.

The maximum tensile strengths of a membrane can be tested by following ASTM D882.

One embodiment of the present disclosure provides a fuel cell mainly comprising anode, cathode, catalyst and a fluorocarbon polymer-based electrolyte. The fuel cell can have a solid membrane configuration or a liquid electrolyte configuration. The fuel cell can use hydrogen, methanol, ethanol, hydrazine, glucose, aldehyde, carboxylic acid and boron-based chemicals as fuel. In one aspect, the fluorocarbon polymer electrolyte can be used between anode and cathode to separate oxidative or reductive fuels. In another aspect, a fluorocarbon polymer electrolyte can be added to an electrode as a catalyst ink to facilitate ion conduction. The fuel cell can be a PEMFC or a PAFC or a methanol fuel cell.

In yet another embodiment, the present disclosure provides an electrolytic cell mainly comprising anode, cathode, catalyst and a fluorocarbon polymer electrolyte.

Another embodiment of the present disclosure provides a metal-air battery mainly comprising anode, cathode, catalyst and a fluoropolymer electrolyte.

In yet another embodiment, the present disclosure provides an electrolytic cell mainly comprising anode, cathode, catalyst and a fluoropolymer electrolyte.

### (4) Methods to Produce a Fluorocarbon Polymer.

A final major portion of the present disclosure provides a method to produce a fluorocarbon polymer comprising a heteroaromatic group or an HPCA.

A general synthetic scheme for the synthesis of a fluorocarbon polymer is shown in scheme 1. In a preferred embodiment, a PFSA is contacted with thionyl chloride to form a sulfonyl chloride compound, which is further contacted with sodium sulfite followed by contact with iodine. The resulting sulfonyl iodide group on the side chain of a fluoropolymer is further contacted with an oxidation agent like t-BuOOH or hydrogen peroxide to remove the —SO₃H group, leading to a free radical intermediate than then reacts with an aromatic or a heteroaromatic compound of A, C or E for grafting a heteroaromatic group or an HPCA.

In another preferred embodiment an analogue of PFSA (e.g., the sulfonyl fluoride form) can be contacted with an oxidation agent or other reagent in the presence of a heteroaromatic compound to from the fluorocarbon polymer.

Those skilled in the art will appreciate that an appropriate solvent can be chosen for each step of the synthetic method. Those solvents can be either organic solvents or water, or a combination. The concentration of reagents can and will vary, depending upon the —SO₃H loading in PFSA, the temperature of the reaction, and so forth. In one embodiment, the molar ratio of two reactants in each step can be 1:100, preferably at 1:20, at 1:10, and most preferably at 1:1.

The temperature at which the esterification reaction is conducted may vary. In general, the temperature of the reaction may range from about 25° C. to about 250° C., and more preferably from about 40° C. to about 250° C. In one embodiment, the temperature of the reaction may be about 60-180° C. In another embodiment, the temperature of the reaction may be about 80-150° C. In still another embodiment, the temperature of the reaction may be about 85° C.

The pressure under which the reaction is conducted may vary. The pressure may range from low pressures, such as 40-60 kPa (˜6-9 psia) to high pressures, such as ˜50-1,000 psia. The process of the invention may also be conducted in the presence of ultrasound and/or microwave.

The duration of the esterification reaction of the invention can and will vary, depending upon the reaction parameters. Typically, the duration of the reaction will be long enough for the reaction to go to completion. Techniques well known in the art, such as gas chromatography (GC), nuclear magnetic resonance (NMR), or mass spectrometry (MS), may be used to determine the completeness of the reaction. The duration of the reaction may range from about five seconds to about 48 hours. In one embodiment, the duration of the reaction may range from about five seconds to about 60 minutes. In another embodiment, the duration of the reaction may range from about one hour to about four hours. In an alternate embodiment, the duration of the reaction may range from about four hours to about eight hours. In yet another embodiment, the duration of the reaction may range from about eight hours to about 12 hours. In another alternate embodiment, the duration of the reaction may range from about 12 hours to about 24 hours. In still another embodiment, the duration of the reaction may range from about 24 hours to about 48 hours. In a preferred embodiment, the duration of the reaction may be about 12 hours.

The process of the invention may be conducted in a batch, a semi-continuous, or a continuous mode. The operations may be suitably carried out using a variety of apparatuses and processing techniques well known to those skilled in the art. Furthermore, some of the operations may be omitted or combined with other operations without departing from the scope of the present invention. In a preferred embodiment, the reaction may be performed in a continuous mode of operation.

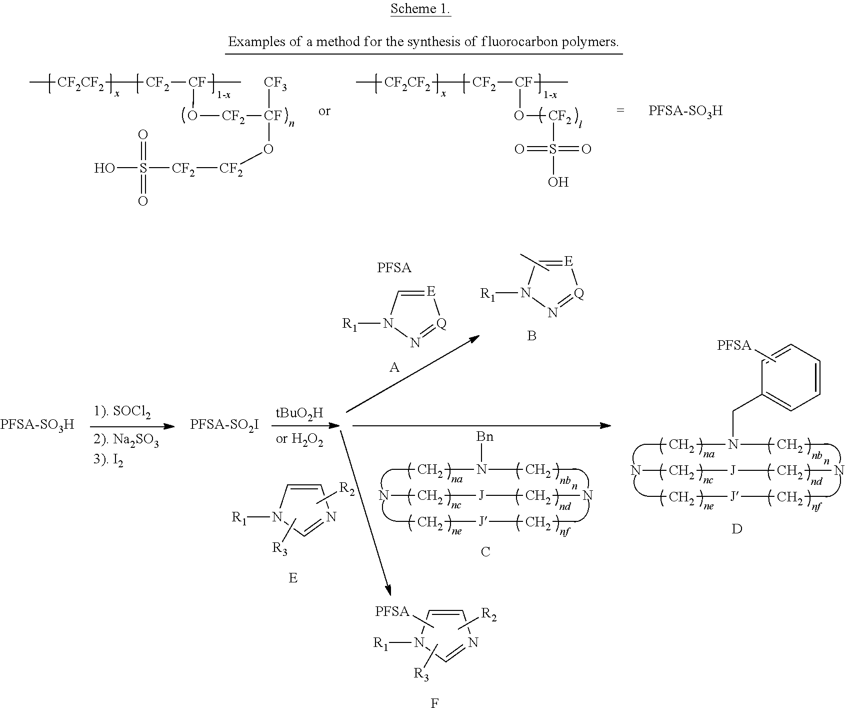

### DEFINITIONS

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

“Aromatic ring” or “aromatic hydrocarbon” or “aromatic group”, abbreviated as “Ar”, refers to a compound that contains a set of covalently bond atoms with the characteristics: (a) a delocalized conjugated π system, most commonly an arrangement of alternating single and double bonds; (b) coplanar structure, with all the contributing atoms in the same plane; (c) contributing atoms arranged in one or more rings; and (d) a total of 4n+2 number of π electrons, where n=0, 1, 2, 3, etc. Aromatic hydrocarbons can be monocyclic or polycyclic and include heteroaromatic hydrocarbons. Examples of aromatic hydrocarbons include benzene, phenol, aniline, triphenylphosphine, triphenylphosphine oxide, biphenyl, acenaphthene, acenaphthylene, anthracene, fluorene, phenanthren, pyrene, pyridine, imidazole, and naphthalene. “—Ar—” refers to a di- or more-substituted aromatic ring with two substituents at ortho-, meta- or para-positions to each other.

“Heteroaromatic ring” or “heteroaromatic group” or “heteroaromatic compound” refers to an aromatic hydrocarbon having at least one non-carbon atom in the ring. Heteroaromatic hydrocarbons can be monocyclic or polycyclic. Examples of heteroaromatic hydrocarbons include quinoline, phenylalanine, phenanthroline, pyridine, pyrrole, imidazole, tetrazole, furan, thiophene, phosphole, arsole, stibole, bismole, silole, triazole, furazan, oxadiazole, thialdiazole, dithiazole, pyrazole, thiazole, isothiazole, oxazole and isoxazole. Heteroaromatic hydrocarbons belong to aromatic hydrocarbons. In the names of some materials having an aromatic or a heteroaromatic group, x(y) represents a substituent can have a covalent bond to either position x or y of the aromatic or heteroaromatic ring. An example is 3(5)-{1,1,2,2-tetrafluoro-2-[1,2,2-trifluoro-2-(1,2,2-trifluoroethenyloxy)-1-(trifluoromethyl)ethoxy]ethyl}-1,2,4-triazole, wherein 4(5) refers to that the fluoroalkly chain is bonded to either the 3 or 5 position of 1,2,4-triazole.

“Imidazole” or “imidazolium” both refers to a five-membered aromatic hydrocarbon with the formula (CH)₂N(NH)CH. It includes two tautomeric forms, because the proton can be located on either of the two nitrogen atoms.

“Triazole” or “triazolium” both refers to a five-membered aromatic hydrocarbon with the formula C₂H₃N₃. It includes four tautomeric forms: 1H-1,2,3-triazole, 2H-1,2,3-triazole, 1H-1,2,4-triazole and 4H-1,2,4-triazole. Herein, 1,2,3-triazole includes both 1H-1,2,3-triazole and 2H-1,2,3-triazole; 1,2,4-triazole includes both 1H-1,2,4-triazole and 4H-1,2,4-triazole.

“Tetrazole” or “tetrazolium” both refers to a five-membered aromatic hydrocarbon with the formula CH₂N₄.

A “covalent bond” is a chemical bond that involves the sharing of electron pairs between atoms. Examples of “covalent bonds” includes C—C bonds, C—N bonds, and C—O bonds.

“Hydrocarbon” refers to an organic compound that mainly consisting of hydrogen and carbon atoms. Examples include octane, benzene, diethyl ether, aniline, and pyridine.

“Fluorocarbon” or “fluoroalkyl” refers to an organic compound derived by replacing all or some of the hydrogen atoms in a hydrocarbon by fluorine atoms (e.g., tetrafluoroethylene).

“Polymer” refers to a compound of high molecular weight derived either by the addition of many smaller molecules, as polyethylene, or by the condensation of many smaller molecules with the elimination of water, alcohol, or the like, as nylon.

A “fluoropolymer” or “fluorocarbon polymer” is a fluorocarbon based polymer with multiple strong carbon-fluorine bonds. Examples include poly(vinyl fluoride), polytetrafluoroethylene, perfluoroalkoxy and poly(chlorotrifluoroethylene).

An “ion-conductive material”, “ion conductive material”, “ion transportation material” or “electrolyte” is a material that can transport an ion from one site to another. Ionic conduction can lead to an electric current. The SI unit of conductivity is Simens per meter (S/m) and, unless otherwise qualified, it generally refers to 25° C. (standard temperature).

The term “anion-conductive” or “anion conductive” refers to the migration of a negatively charged ion from one side to another in a medium.

The term “cation-conductive” or “cation conductive” refers to the migration of a positively charged ion from one side to another in a medium.

The term “solid” refers to a solid state of matter under a temperature ranging from −70 to 200° C.

A “heteropolycyclic alkane”, or “cyclic heteroalkane”, abbreviated as “HPCA”, refers to a repeated unit of a cyclic compound with one or more hydrocarbon loop or ring structures, which contains atoms of at least two different elements. RU(HPCA) refers to the repeated unit selected from the structures of (X), (XI) and (XII):

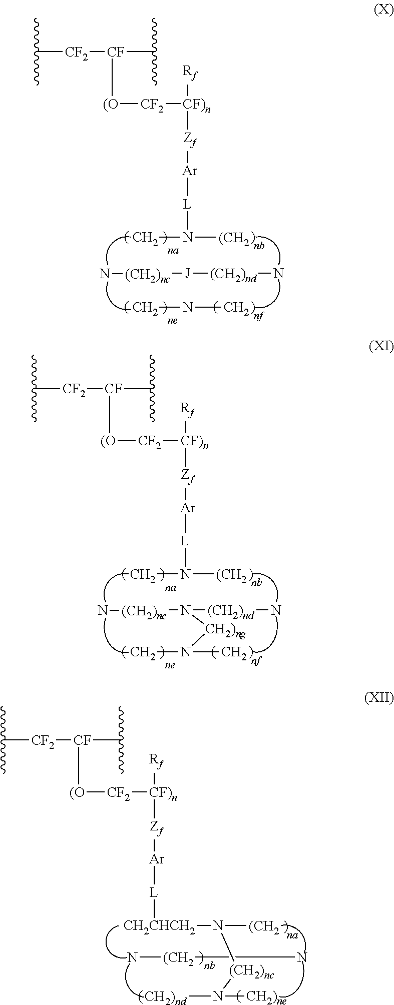

wherein wavy lines indicate the points of attachment to adjacent repeating units of the polymer; —R_{f} is either —F or —CF₃; n is an integer number of either 1 or 2 and it represents the number of the repeating unit of —OCF₂CFR_{f}—; —Z_{f}— is selected from a group of a direct bond, —CF₂—, —CF₂CF₂—, and —OCF₂CF₂—; —Ar— is selected from a direct bond, and a di- or higher substituted aromatic or heteroaromatic group having a structure selected from the following:

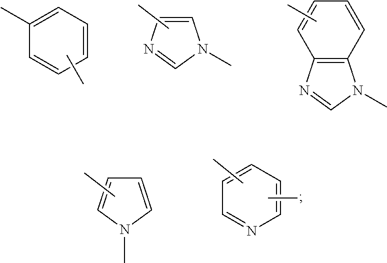

-L- is selected from a direct bond, —(CH₂)ₘ—, —(CH₂O)ₘ—, —(CH₂CH₂O)ₘ—, and —(CH₂CH₂NH)ₘ—, wherein n is an integer that ranges from 1 to 6; na, nb, nc, nd, nf and ng are an integer number of either 2 or 3 and they represent the number of the repeating unit of —CH₂—; -J- and -J′- in (X) are either —O—, or —NR″, wherein R″ is either H or a (C₁-C₆)hydrocarbon.

The term “interaction” or “interactions” refers to any of several forces, especially the ionic bond, hydrogen bond, covalent bond, and metallic bond, by which atoms or ions are bound in a molecule or crystal.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

The terms “selected”, “chosen” and “or” refer to make one or more choices including a combination of choices from a number of possibilities.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

Citation of a reference herein shall not be construed as an admission that such is prior art to the present disclosure.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

### EXAMPLES

The following non-limiting examples are provided to further illustrate the present disclosure. It should be appreciated by those of skill in the art that the techniques disclosed in the examples that follow represent approaches the inventors have found function well in the practice of the present disclosure, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the present disclosure.

The following examples illustrate various embodiments of the disclosure. Chemicals and organic solvents mentioned below were purchased from Aldrich (Milwaukee, Wis.) or Acros Organics (Pittsburgh, Pa.) and used as received. Water was obtained from a Milli-Q water system purchased from Millipore Corporation (Milford, Mass.). The heavy metal and bacterial contaminant levels in Milli-Q water were below 10 parts per billion. The beads, membranes and aqueous solutions of Nafion® and Aquivion® were purchased from Ion Power, Sigma Aldrich and Solvay Plastics. BT-112 Conductivity Cell from Scrinber Associates (S. Pine, N.C.) was used for in-plane conductivity tests. CHI6112D Electrochemical Analyzer from CHI Instruments, Inc. (Austin, Tex.) and UBA5 Battery Analyzer from AA Battery Power Co. (Richmond, Calif.) were employed for analyzing the fuel cell performance. The in-plane ion conductivity of a membrane was typically measured at 25° C. in Milli-Q water using a four-electrode impedance method. The ionic conductivity (G) was calculated from current resistance (R) using an equation σ=L/[R·A], wherein A is the cross section area of membrane for resistance measurement and L is the length of two electrodes.

### Example 1

### Synthesis of the copolymer of tetrafluoroethylene and 3(5)-{1,1,2,2-tetrafluoro-2-[1,2,2-trifluoro-2-(1, 2,2-trifluoroethenyloxy)-1-(trifluoromethyl)ethoxy]ethyl}-1,2,4-triazole (Polymer 1)

Nafion® NR50 beads or film (0.250 g) were refluxed under nitrogen in 2 mL thionyl chloride at 80° C. After 12 h, thionly chloride was removed by decanting. The polymer was washed with 10 mL×4 CH₂Cl₂ and dried under vacuum. The polymer was then introduced to an 8 mL aqueous solution of Na₂SO₃ (7.0 mmol) and NaHCO₃ (7.0 mmol) at 70° C. for 14 h. Then, the polymer was removed and washed with water 20 mL×3 and dried. The polymer was further introduced to the mixture of iodine (0.4 mmol) in EtOH (2 mL) and water (15 mL) at 60° C. After 3 h, the mixture was cooled down to ambient temperature. The polymer was removed by centrifuge and washed with EtOH (20 mL×3). Then, a mixture of this polymer, 1,2,4-triazole (1.25 mmol), trifluoroacetic acid (1.25 mmol) and t-butyl hydroperoxide (1.25 mmol) in DMSO (5 mL) was brought to 60° C. After 14 h, the solution was cooled down to ambient temperature. The solvent was removed and the polymer was thoroughly washed by CHCl₃ (20 mL×8). The copolymer was further purified using a Soxhlet extractor with methanol for 24 h to remove non-bonded impurities to yield polymer 1 as solid (˜252 mg): ¹H NMR (400 MHz, DMSO-d6): δ 8.82 (1H, s); elemental analysis (wt %): S (0.0); C (30.89), H (0.16), N (3.65).

120 mg of polymer 1 was stirred in 1M H₂SO₄ solution (20 mL) for 12 h. The polymer was isolated via filtration, washed with water (20 mL×3) and dried under vacuum at 60° C. for 12 h to yield its sulfuric acid composite (117 mg). Elemental analysis found S at 1.44 wt %.

The phosphoric acid composite was achieved by mixing 1M H₃PO₄ (20 mL) and 120 mg of polymer 1. After 12 h, the polymer was removed via filtration and washed with water (20 mL×3) to yield the phosphoric acid composite.

### Example 2

### Synthesis of the copolymer of tetrafluoroethylene and 4(5)-{1,1,2,2-tetrafluoro-2-[1,2,2-trifluoro-2-(1, 2,2-trifluoroethenyloxy)-1-(trifluoromethyl)ethoxy]ethyl}-1,2,3-triazole (Polymer 2)

The same procedure used in example 1 was adopted except that Nafion® NR50 beads and 1,2,3-triazole were used to replace Nafion® NR40 and 1,2,4-triazole, respectively. Polymer 2 was obtained as solid (˜192 mg): ¹H NMR (400 MHz, DMSO-d6): δ 8.60 (1H, s).

The composite of polymer 2 and sulfuric acid was achieved by mixing polymer B (150 mg) with 1M H₂SO₄ solution (20 mL) for 12 h. After filtration isolation, the composite was washed with water (20 mL×3) and dried under vacuum at 60° C. for 12 h to yield 143 mg.

### Example 3

### Synthesis of the copolymer of tetrafluoroethylene and 4(5)-{1,1,2,2-tetrafluoro-2-[1,2,2-trluoluoro-2-(1,2,2-trifluoroethenyloxy)-1-(trifluoromethyl)ethoxy]ethyl}-2,2′-biimidazole (Polymer 3)

The same procedure used in example 1 was adopted except that 2,2′-bimidazole was used to replace 1,2,4-triazole. Polymer 3 was obtained as solid.

The composite of this copolymer and sulfuric acid was achieved by mixing the copolymer (120 mg) with 1M H₂SO₄ solution (20 mL) for 12 h. After filtration isolation, the composite was washed with water (20 mL×3) and dried under vacuum at 60° C. for 12 h.

### Example 4

### Synthesis of the copolymer of tetrafluoroethylene and 5(6)-{1,1,2,2-tetrafluoro-2-[1,2,2-trluoluoro-2-(1,2,2-trifluoroethenyloxy)-1-(trifluoromethyl)ethoxy]ethyl}-benzotriazole (Polymer 4)

The same procedure used in example 1 was adopted except that benzotriazole was used to replace 1,2,4-triazole. Polymer 4 was obtained as solid: ¹H NMR (400 MHz, DMSO-d6): δ 7.80-7.55 (1H, br), 7.44-7.20 (2H, br).

The composite of this copolymer and sulfuric acid was achieved by mixing polymer 4 (150 mg) with 1M H₂SO₄ solution (20 mL) for 12 h. After filtration isolation, the composite was washed with water (20 mL×3) and dried under vacuum at 60° C. for 12 h.

### Example 5

### Synthesis of the copolymer of tetrafluoroethylene and 3(4)-{1,1,2,2-tetrafluoro-2-[1,2,2-trluoluoro-2-(1,2,2-trifluoroethenyloxy)-1-(trifluoromethyl)ethoxy]ethyl}-2-nitro-imidazole (Polymer 5)

The same procedure used in example 1 was adopted except that 3-nitro-1,2,4-triazole was used to replace 1,2,4-triazole. Polymer 5 was obtained as solid: ¹H NMR (400 MHz, DMSO-d6): δ 7.24 (1H, s).

The composite of this polymer and sulfuric acid was achieved by mixing the copolymer (120 mg) with 1M H₂SO₄ solution (20 mL) for 12 h. After filtration isolation, the composite was washed with water (20 mL×3) and dried under vacuum at 60° C. for 12 h.

### Example 6

### Synthesis of the copolymer of tetrafluoroethylene and 3-(5-{1,1,2,2-tetrafluoro-2-[1,2,2-trluoluoro-2-(1,2,2-(1,2,2-trifluoroethenyloxy)-1-(trifluoromethyl)ethoxy]ethyl}-1,2,4-triazole)sulfonic acid (Polymer 6)

The copolymer of tetrafluoroethylene and 3(5)-{1,1,2,2-tetrafluoro-2-[1,2,2-trifluoro-2-(1,2,2-trifluoroethenyloxy)-1-(trifluoromethyl)ethoxy]ethyl}-1,2,4-triazole (100 mg) was mixed with 20 mL fuming sulfuric acid and 4 mL chlorosulfonic acid. After at 120° C. for 60 h, the mixture was cooled down to ambient temperature. The polymer was washed with EtOH (20 mL×3) and then with water (20 mL×3) and the polymer was dried at 60° C. under vacuum for 12 h. ¹H NMR (400 MHz, DMSO-d6): no major ¹H signal between δ 7.0 and 9.0; elemental analysis (wt %): S (2.14).

### Example 7

### Synthesis of the copolymer of tetrafluoroethylene and 2(4)-{1,1,2,2-tetrafluoro-2-[1,2,2-trluoluoro-2-(1,2,2-trifluoroethenyloxy)-1-(trifluoromethyl)ethoxy]ethyl}-imidazole (Polymer 7)

The same procedure used in example 1 was adopted except that imidazole was used to replace 1,2,4-triazole. Polymer 7 was obtained as solid: ¹H NMR (400 MHz, DMSO-d6): δ 8.30 (1H, s), 7.80 (1H, s).

The composite of polymer 7 and sulfuric acid was achieved by mixing the copolymer (120 mg) with 1M H₂SO₄ solution (20 mL) for 12 h. After filtration isolation, the composite was washed with water (20 mL×3) and dried under vacuum at 60° C. for 12 h.

### Example 8

### Synthesis of the copolymer of tetrafluoroethylene and 3(5)-{1,1,2,2-tetrafluoro-2-[1,2,2-trluoluoro-2-(1,2,2-trifluoroethenyloxy)-1-(trifluoromethyl)ethoxy]ethyl}-2,4-dinitro-N-butyl-aniline (Polymer 8)

The same procedure used in example 1 was adopted except that 2,4-dinitro-N-butyl-anliline was used to replace 1,2,4-triazole. Polymer 8 was obtained as solid. The sulfuric acid composite of this polymer was achieved via the similar procedure as that in example 1.

### Example 9

### Synthesis of the copolymer of tetrafluoroethylene and 2(4)-{1,1,2,2-tetrafluoro-2-[1,2,2-trluoluoro-2-(1,2,2-trifluoroethenyloxy)-1-(trifluoromethyl)ethoxy]ethyl}-3,5-bis(trifluoromethyl)-aniline (Polymer 9)

The same procedure used in example 1 was adopted except that 3,5-bis(trifluoromethyl)aniline was used to replace 1,2,4-triazole. Polymer 9 was obtained as solid: ¹H NMR (400 MHz, DMSO-d6): δ 7.08 (1H, s), 6.95 (1H, s).

The composite of polymer 9 and sulfuric acid was achieved by mixing the copolymer (120 mg) with 1M H₂SO₄ solution (20 mL) for 12 h. After filtration isolation, the composite was washed with water (20 mL×3) and dried under vacuum at 60° C. for 12 h.

### Example 10

### Synthesis of the copolymer of tetrafluoroethylene and 4-{1,1,2,2-tetrafluoro-2-[1,2,2-trluoluoro-2-(1,2,2-trifluoroethenyloxy)-1-(trifluoromethyl)ethoxy]ethyl}-2,3,5,6-tetafluoroaniline (Polymer 10)

The same procedure used in example 1 was adopted except that 2,3,5,6-tetrafluoroaniline was used to replace 1,2,4-triazole. Polymer 10 was obtained as solid: ¹H NMR (400 MHz, DMSO-d6): no major signal between δ 7.0 and 9.0; elemental analysis (wt %): N (0.95).

The composite of polymer 10 and sulfuric acid was achieved by mixing the copolymer (120 mg) with 1M H₂SO₄ solution (20 mL) for 12 h. After filtration isolation, the composite was washed with water (20 mL×3) and dried under vacuum at 60° C. for 12 h.

### Example 11

### Synthesis of poly{1,1,2,2-tetrafluoro-2-[1,2,2-trifluoro-2-(1,2,2-trifluoroethenyloxy)-1-(trifluoromethyl)ethoxy]ethylsulfonic acid} (Polymer 11)

The homopolymer of {1,1,2,2-tetrafluoro-2-[1,2,2-trifluoro-2-(1,2,2-trifluoroethenyloxy)-1-(trifluoromethyl)ethoxy]ethyl}sulfonyl fluoride (CAS 16090-14-5) was synthesized by following the protocols reported by Flach et al. (Polym. Chem. 2013, 4, 3370-3383). Then, 223 mg of this homopolymer was treated with LiOH (0.75 mmol) in a mixture of DMSO (5 mL) and water (5 mL). After 48 h, the solvents were removed in vacuo. The residue was acidified by 5 mL of 0.1 M HCl followed by removing HCl solution in vacuo. Polymer 11 was dried in a vacuum oven at 80° C. for 48 h.

### Example 12

### Synthesis of poly[1,1,2,2-tetrafluoro-2-(trifluoroethenyloxy)ethanesulfonic acid] (Polymer 12)

The homopolymer of 1,1,2,2-tetrafluoro-2-(trifluoroethenyloxy)ethanesulfonyl fluoride (CAS 29514-94-1) was synthesized by modifying the protocols reported by Flach et al. (Polym. Chem. 2013, 4, 3370-3383): 5 g of 1,1,2,2-tetrafluoro-2-(trifluoroethenyloxy)ethanesulfonyl fluoride containing 2 wt % perfluorobenzoyl peroxide was placed in a pressure reactor with a stirring bar. The reactor was pressurized to 150 psi and heated to 75° C. for 72 h. Unreacted monomers were removed by a rotovaporator.

Then, the polymer was treated with 1.5 molar equivalent of LiOH in a mixture of DMSO (5 mL) and water (5 mL). After 48 h, the solvents were removed in vacuo. The residue was acidified by 5 mL of 0.1 M HCl followed by removing HCl solution in vacuo. The homopolymer was dried in a vacuum oven at 80° C. for 48 h to yield polymer 12.

### Example 13

### Synthesis of poly{3(5)-{1,1,2,2-tetrafluoro-2-[1,2,2-trifluoro-2-(1,2,2-trifluoroethenyloxy)-1-(trifluoromethyl)ethoxy]ethyl}-1,2,4-triazole}(Polymer 13)

Poly{1,1,2,2-tetrafluoro-2-[1,2,2-trifluoro-2-(1,2,2-trifluoroethenyloxy)-1-(trifluoromethyl)ethoxy]ethylsulfonic acid} synthesized via example 11 (0.110 g) were refluxed under nitrogen in 2 mL thionyl chloride at 80° C. After 12 h, thionly chloride was removed by decanting. The polymer was washed with 10 mL×4 CH₂Cl₂ and dried under vacuum. The polymer was then introduced to a 8 mL aqueous solution of Na₂SO₃ (7.0 mmol) and NaHCO₃ (7.0 mmol) at 70° C. for 14 h. Then, the polymer was removed and washed with water 20 mL×3 and dried. The polymer was further introduced to the mixture of iodine (0.4 mmol) in EtOH (2 mL) and water (15 mL) at 60° C. After 3 h, the mixture was cooled down to ambient temperature. The polymer was removed by centrifuge and washed with EtOH (20 mL×3). Then, a mixture of the polymer, 1,2,4-triazole (1.25 mmol), trifluoroacetic acid (1.25 mmol) and t-butyl hydroperoxide (1.25 mmol) in DMSO (5 mL) was brought to 60° C. After 14 h, the solution was cooled down to ambient temperature. The solvent was removed and the polymer was thoroughly washed by CHCl₃ (20 mL×8). The polymer was further purified using a Soxhlet extractor with methanol for 24 h to remove non-bonded impurities to yield polymer 13: ¹H NMR (400 MHz, DMSO-d6): δ 8.80 (1H, s); elemental analysis (wt %): S (0.0).

120 mg of polymer 13 was stirred in 1M H₂SO₄ solution (20 mL) for 12 h. The polymer was isolated via filtration, washed with water (20 mL×3) and dried under vacuum at 60° C. for 12 h to yield its sulfuric acid composite.

The phosphoric acid composite was achieved by mixing 1M H₃PO₄ (20 mL) and 120 mg of polymer 13. After 12 h, the polymer was removed via filtration and washed with water (20 mL×3) to yield the phosphoric acid composite.

### Example 14

### Synthesis of poly{2(4)-{1,1,2,2-tetrafluoro-2-[1,2,2-trifluoro-2-(1,2,2-trifluoroethenyloxy)-1-(trifluoromethyl)ethoxy]ethyl}-imidazole}) (Polymer 14)

The same procedure used in example 13 was adopted except that imidazole was used to replace 1,2,4-triazole. ¹H NMR (400 MHz, DMSO-d6): δ 8.28 (1H, s), 7.80 (1H, s). The sulfuric acid composite of the polymer was achieved by mixing the polymer with 1M H₂SO₄, similar to the procedure in example 13.

### Example 15

### Synthesis of poly{2(4)-{1,1,2,2-tetrafluoro-2-[1,2,2-trifluoro-2-(1,2,2-trifluoroethenyloxy)-1-(trifluoromethyl)ethoxy]ethyl}-3,5-bis(trifluoromethyl)-aniline} (Polymer 15)

The same procedure used in example 13 was adopted except that 3,5-bis(trifluoromethyl)aniline was used to replace 1,2,4-triazole. Polymer 15 was obtained as solid: ¹H NMR (400 MHz, DMSO-d6): δ 7.08 (1H, s), 6.95 (1H, s).

### Example 16

### Synthesis of the copolymer of tetrafluoroethylene and 3(5)-[1,1,2,2-tetrafluoro-2-(trifluoroethenyloxy)ethyl]-1,2,4-triazole (Polymer 16)

The copolymer of tetrafluoroethylene and 1,1,2,2-tetrafluoro-2-(trifluoroethenyloxy)ethanesulfonic acid were either purchased from Solvay Polymer Plastics (e.g., Aquivion® D83) or produced by copolymerization of tetrafluoroethylene and 1,1,2,2-tetrafluoro-2-(trifluoroethenyloxy)ethanesulfonyl fluoride followed by hydrolysis and acidification, using a protocol similar to that in example 12. For Aquivion® D83, the solvents were removed in vacuo to yield a dry polymer. Then, in a typical experiment, about 0.200 g of the polymer was refluxed under nitrogen in 2 mL thionyl chloride at 80° C. After 12 h, thionly chloride was removed by decanting. The polymer was washed with 10 mL×4 CH₂Cl₂ and dried under vacuum. The polymer was then introduced to a 8 mL aqueous solution of Na₂SO₃ (7.0 mmol) and NaHCO₃ (7.0 mmol) at 70° C. for 14 h. Then, the polymer was removed and washed with water 20 mL×3 and dried. The polymer was further introduced to the mixture of iodine (0.4 mmol) in EtOH (2 mL) and water (15 mL) at 60° C. After 3 h, the mixture was cooled down to ambient temperature. The polymer was removed by centrifuge and washed with EtOH (20 mL×3). Then, a mixture of this polymer, 1,2,4-triazole (1.0 mmol), trifluoroacetic acid (1.0 mmol) and t-butyl hydroperoxide (1.0 mmol) in DMSO (5 mL) was brought to 60° C. After 14 h, the solution was cooled down to ambient temperature. The solvent was removed and the polymer was thoroughly washed by CHCl₃ (20 mL×8). The copolymer was further purified using a Soxhlet extractor with methanol for 24 h to remove non-bonded impurities to yield polymer 16 as solid (˜180 mg): ¹H NMR (400 MHz, DMSO-d6): δ 8.86 (1H, s); elemental analysis (wt %): S (0.0).

100 mg of polymer 16 was stirred in 1M H₂SO₄ solution (20 mL) for 12 h. The copolymer was isolated via filtration, washed with water (20 mL×3) and dried under vacuum at 60° C. for 12 h to yield its sulfuric acid composite.

The phosphoric acid composite was achieved by mixing 1M H₃PO₄ (20 mL) and 100 mg of polymer 16. After 12 h, the copolymer was removed via filtration and washed with water (20 mL×3) to yield the phosphoric acid composite.

### Example 17

### Synthesis of the copolymer of tetrafluoroethylene and 4(5)-[1,1,2,2-tetrafluoro-2-(trifluoroethenyloxy)ethyl]-1,2,3-triazole (Polymer 17)

The same procedure used in example 16 was adopted except that 1,2,3-triazole was used to replace 1,2,4-triazole. Its sulfuric acid composite was achieved by mixing 120 mg of the polymer with 1M H₂SO₄ (20 mL) followed by filtration and washing the polymer extensively with water.

### Example 18

### Synthesis of the copolymer of tetrafluoroethylene and 2(4)-[1,1,2,2-tetrafluoro-2-(trifluoroethenyloxy)ethyl]-imidazole (Polymer 18)

The same procedure used in example 16 was adopted except that imidazole was used to replace 1,2,4-triazole to yield solid polymer 18 (175 mg): ¹H NMR (400 MHz, DMSO-d6): δ 7.25 (1H, s). Its sulfuric acid composite was achieved by mixing 80 mg of polymer 18 with 1M H₂SO₄ (20 mL) followed by filtration and washing the polymer extensively with water. The phosphoric acid composite was achieved by mixing 1M H₃PO₄ (20 mL) and 100 mg of polymer 18. After 12 h, the copolymer was removed via filtration and washed with water (20 mL×3) to yield the phosphoric acid composite.

### Example 19

### Synthesis of the copolymer of tetrafluoroethylene and 4-[1,1,2,2-tetrafluoro-2-(trifluoroethenyloxy)ethyl]-2,3,5,6-tetafluoroaniline (Polymer 19)

The same procedure used in example 16 was adopted except that 2,3,5,6-tetafluoroaniline was used to replace 1,2,4-triazole to yield solid polymer 19 (190 mg): ¹H NMR (400 MHz, DMSO-d6): no major ¹H signal between δ 7.0 and 9.0; elemental analysis (wt %): S (0.0), N (1.21). Its sulfuric acid composite was achieved by mixing polymer 19 (125 mg) with 1M H₂SO₄ (20 mL) followed by filtration, washing the polymer extensively with water and dried in vacuo. The phosphoric acid composite was achieved by mixing 1M H₃PO₄ (20 mL) and 100 mg of polymer 19. After 12 h, the copolymer was removed via filtration and washed with water (20 mL×3) to yield the phosphoric acid composite.

### Example 20

### Synthesis of the copolymer of tetrafluoroethylene and 2(4)-[1,1,2,2-tetrafluoro-2-(trifluoroethenyloxy)ethyl]-3,5-bis(trifluoromethyl)-aniline (Polymer 20)

The same procedure used in example 16 was adopted except that 3,5-bis(trifluoromethyl)aniline was used to replace 1,2,4-triazole. Polymer 20 was obtained as solid: ¹H NMR (400 MHz, DMSO-d6): δ 7.11 (1H, s), 6.95 (1H, s).

### Example 21

### Synthesis of poly{3(5)-[1,1,2,2-tetrafluoro-2-(trifluoroethenyloxy)ethyl]-1,2,4-triazole} (Polymer 21)

Poly[1,1,2,2-tetrafluoro-2-(trifluoroethenyloxy)ethanesulfonic acid]synthesized via example 12 (0.280 g) were refluxed under nitrogen in 2 mL thionyl chloride at 80° C. After 12 h, thionly chloride was removed by decanting. The polymer was washed with 10 mL×4 CH₂Cl₂ and dried under vacuum. The polymer was then introduced to a 8 mL aqueous solution of Na₂SO₃ (35.0 mmol) and NaHCO₃ (35.0 mmol) at 70° C. for 14 h. Then, the polymer was removed and washed with water 20 mL×3 and dried. The polymer was further introduced to the mixture of iodine (0.5 mmol) in EtOH (2 mL) and water (15 mL) at 60° C. After 3 h, the mixture was cooled down to ambient temperature. The polymer was removed by centrifuge and washed with EtOH (20 mL×3). Then, a mixture of the polymer, 1,2,4-triazole (5 mmol), trifluoroacetic acid (5 mmol) and t-butyl hydroperoxide (5 mmol) in DMSO (5 mL) was brought to 60° C. After 14 h, the solution was cooled down to ambient temperature. The solvent was removed and the polymer was thoroughly washed by CHCl₃ (20 mL×8). The polymer was further purified using a Soxhlet extractor with methanol for 24 h to remove non-bonded impurities to yield polymer 21 (202 mg): ¹H NMR (400 MHz, DMSO-d6): δ 8.80 (1H, s); elemental analysis (wt %): S (0.0). Its sulfuric acid composite was achieved by mixing polymer 21 (100 mg) with 1M H₂SO₄ (20 mL) followed by filtration, washing the polymer extensively with water and dried in vacuo. The phosphoric acid composite of 21 was achieved by mixing 1M H₃PO₄ (20 mL) and 100 mg of polymer 21. After 12 h, the copolymer was removed via filtration and washed with water (20 mL×3) to yield the phosphoric acid composite.

### Example 22

### Synthesis of poly{2(5)-[1,1,2,2-tetrafluoro-2-(trifluoroethenyloxy)ethyl]-1,2,3-triazole} (Polymer 22)

The same procedure of example 21 was adopted except 1,2,3-triazole was used to replace 1,2,4-triazole to yield 150 mg of the polymer: ¹H NMR (400 MHz, DMSO-d6): δ 8.60 (1H, s).

### Example 23

### Synthesis of poly{2(4)-[1,1,2,2-tetrafluoro-2-(trifluoroethenyloxy)ethyl]-imidazole} (Polymer 23)

The same procedure of example 21 was adopted except imidazole was used to replace 1,2,4-triazole to yield 160 mg of polymer 23: ¹H NMR (400 MHz, DMSO-d6): δ 8.28 (1H, s), 7.80 (1H, s). The sulfuric acid composite of the polymer was achieved by mixing the polymer with 1M H₂SO₄, similar to the procedure in example 21. The phosphoric acid composite was achieved by mixing 1M H₃PO₄ (20 mL) and 100 mg of polymer 23. After 12 h, the copolymer was removed via filtration and washed with water (20 mL×3) to yield the phosphoric acid composite of 23.

### Example 24

### Comparison of the Chemical and Thermal Stability of Nafion®, a Mixture of Nafion® and Triazole, and the Fluorocarbon with a Covalently Bonded Triazole

Soxhlet extraction: NR50 Nafion® (250 mg) blended with 1,2,4-triazole (1.25 mmol) were subjected to methanol extraction in a Soxhlet extractor using methanol as the extraction solvent. After 24 h, the solid mixture was removed from the extractor and dried in vacuo. No triazole was found in the mixture by a ¹H NMR (400 MHz, DMSO-d6) experiment—the δ 8.82 signal disappeared. In comparison, as indicated before, the fluorocarbon polymer in example 1 was subject to methanol Soxhlet extraction for 24 h. ¹H NMR and elemental analysis experiments all confirmed the presence of the triazole ring bonded the polymer.

Hydrolysis I: NR50 Nafion® (250 mg) physically blended with 1,2,4-triazole (1.25 mmol) were treated with a 0.5M LiOH solution (20 mL). After 48 h, the solid polymer was removed via filtration. No triazole was found in the mixture by a ¹H NMR (400 MHz, DMSO-d6) experiment. In comparison, the fluorocarbon polymer with bonded triazole in example 1 treated with a 0.5M LiOH solution (20 mL) for 48 h. Then, the polymer was removed via filtration. ¹H NMR experiments confirmed the presence of the triazole ring bonded the polymer.

Hydrolysis II: 250 mg of poly(PSEPVE) diphenyl sulfonamide (Polym. Chem. 2013, 4, 3370) was mixed with a 0.5M LiOH solution (20 mL). After 48 h, the solid polymer was removed via filtration. The diphenyl group was not found in the mixture by a ¹H NMR (400 MHz, DMSO-d6) experiment and the sulfonamide bond was hydrolyzed.

Hydrolysis III: 250 mg of poly(PSEPVE) diphenyl sulfonamide (Polym. Chem. 2013, 4, 3370) was mixed with a 1M H₂SO₄ solution (20 mL). After five days, the solid polymer was removed via filtration. The diphenyl group was not found in the mixture by a ¹H NMR (400 MHz, DMSO-d6) experiment and the sulfonamide bond was hydrolyzed. In comparison, the fluorocarbon polymer with bonded triazole in example 1 was treated under the same conditions. ¹H NMR experiments confirmed the presence of the triazole ring bonded the polymer.

Thermal stability: a Nafion®-117 film (2 cm×2 cm) was immersed in 20 mL of hot water of 150° C. inside a pressure reactor. At a fixed time interval, a small piece of the Nafion®-117 film was taken out and its in-plane ion conductivity was measured at 25° C. in de-ionized Milli-Q water via four-electrode AC impedance measurements. Within 6 h, the ion conductivity of Nafion®-117 was found to drop from 77 mS/cm to less than 2.1 mS/cm. In comparison, a solid membrane produced from the composite of the triazole-containing fluorocarbon polymer and sulfuric acid from example 25 showed less than 5% reduction of its ion conductivity of 70 mS/cm after being heated in 150° C. water after 3,600 h.

### Example 25

### Comparison of the Ion Conductivity, Mechanic Properties of the Solid Film Prepared Via Different Membrane Production Methods

Organic solvent casting: 220 mg of polymer 1 of example 1 was dissolved in 10 mL DMSO at 120° C. Then, the mixture was poured into a 4.8 cm glass dish and the solvent was removed slowly under vacuum at 80° C. for 48 h followed by at 120° C. for 2 h. The membrane was boiled in 1M H₂SO₄ (20 mL) for 1 h, washed by deionized water until the washing water is neutral and further boiled in water for 1 h. The membrane was found to be 114 microns thick and has an in-plane ion conductivity of 43 mS/cm 25° C. in de-ionized Milli-Q water via four-electrode AC impedance measurements. At 25° C. under 50% relative humidity, the membrane that was dried under vacuum at 60° C. for 12 h was found to have the maximum tensile strength in the machine direction for sheet processing (MD) to be 37 MPa and the maximum tensile strength in the transverse direction (TD) vertical to the MD direction at 32 MPa.

Water/alcohol casting: polymer 1 of example 1 was dissolved in a 50 wt %/50 wt % mixture of water and ethanol at 200° C. under 1,000 psi in a pressure reactor. The polymer concentration was 5 wt %. Then, 15 mL of the water/ethanol solution was poured into either a 4.8 cm glass dish or a PTFE dish. The solvents were slowly removed at 60° C. in an oven. No membrane was formed. The polymer was found to be comprised of small pieces of flakes.

Hot pressing: 200 mg of polymer 1 after removal of water was hot pressed under 5,000 psi pressure at 220° C. for 30 min. The formed film was then boiled in 1M H₂SO₄ (20 mL) for 1 h, washed by deionized water until the washing water is neutral and further boiled in water for 1 h. The membrane was found to be 155 microns thick and has an in-plane ion conductivity of 70 mS/cm 25° C. in de-ionized Milli-Q water via four-electrode AC impedance measurements. At 25° C. under 50% relative humidity, the membrane that was dried under vacuum at 60° C. for 12 h was found to have the maximum tensile strength of 33 MPa in MD and 31 MPa in TD.

### Example 26

### Fabrication of a solid electrolyte film comprising e-PTFE, the copolymer of tetrafluoroethylene and 3(5)-{1,1,2,2-tetrafluoro-2-[1,2,2-trifluoro-2-(1,2,2-trifluoroethenyloxy)-1-(trifluoromethyl)ethoxy]ethyl}-1, 2,4-triazole and sulfuric acid/phosphoric acid

Two methods were utilized to synthesize a solid electrolyte membrane:

Membrane pressing, a film (30 microns) of polymer 1 of example 1 was hot pressed onto one side of an expanded PTFE (e-PTFE) film at 120° C. under 5,000 psi for 30 min. The formed composite membrane was boiled in 1M H₂SO₄ (20 mL) for 1 h, washed by deionized water until the washing water is neutral and further boiled in water for 1 h. Table 1 shows the in-plane ion conductivity of the composite membrane measured at 25° C. in de-ionized water. e-PTFE films (A to H) with different thickness and densities were used to support polymer 1 of example 1.

TABLE 1
Ion conductivity of the composite membranes produced by the hot pressing method.

| Sample | No ePTFE | A | B | C | D | E | F | G | H |
|---|---|---|---|---|---|---|---|---|---|
| ePTFE thickness | 0 | 50 | 100 | 100 | 125 | 200 | 150 | 75 | 50 |
| (microns) | | | | | | | | | |
| ePTFE density | N/A | 1.6 | 0.7 | 0.4 | 0.7 | 0.5 | 0.5 | 0.5 | 0.5 |
| (g/cm³) | | | | | | | | | |
| Composite Conductivity | 71 | 38 | 47 | 50 | 43 | 41 | 43 | 48 | 62 |
| (mS/cm) | | | | | | | | | |

Solution impregnation: an ePTFE film (diameter 4.8 cm) was immersed into a 4.8 cm glass dish containing polymer 1 of example 1 in a water/ethanol mixed solvent at 5 wt % (2 g). The solvents were removed slowly at 60° C. for 12 h and then the composite membrane was hot pressed under 5,000 psi pressure at 120° C. for 30 min. The formed film was then boiled in 1M H₂SO₄ (20 mL) for 1 h, washed by deionized water until the washing water is neutral and further boiled in water for 1 h. e-PTFE films with a thickness ranging from 50 to 200 microns and the density from 0.4 to 1.6 g/cm³ were used to support polymer 1 of example 1.

The phosphoric acid composites were achieved similarly using the procedures above except 1M H₃PO₄ was used to replace H₂SO₄.

### Example 27

### Fabrication of a solid electrolyte film comprising e-PTFE, the copolymer of tetrafluoroethylene and 3(5)-{1,1,2,2-tetrafluoro-2-[1,2,2-trifluoro-2-(1,2,2-trifluoroethenyloxy)-1-(trifluoromethyl)ethoxy]ethyl}-1, 2,4-triazole and sulfuric acid/phosphoric acid

The same procedures including membrane pressing and solution impregnation used in example 26 were used to fabricate the composite membrane of polymer 16 of example 16 except polymer 16 was used to replace polymer 1. The e-PTFE supports are the same as those in table 1 with a thickness of 50 to 200 microns and the density from 0.4 to 1.6 g/cm³.

The phosphoric acid composite of polymer 16 was achieved similarly by using 1M H₃PO₄ instead of H₂SO₄.

### Example 28

### Fabrication of a solid electrolyte film comprising a metal-organic-framework (MOF) of the copolymer of tetrafluoroethylene and 3(5)-{1,1,2,2-tetrafluoro-2-[1,2,2-trluoluoro-2-(1,2,2-trifluoroethenyloxy)-1-(trifluoromethyl)ethoxy]ethyl}-1,2,4-triazole (Polymer 28)

MOF of Zn₂(C₂O₄)(C₂N₄H₃)₂(H₂O)_{0.5} was synthesized by following the known procedures (Chem. Commun., 2009, 5230). Then, the MOF was added to a 10 mL NMP solution of polymer 1 of example 1 (2 wt %) at a concentration of 0.1 M. The mixture was treated for 40 min in ultrasound bath and it was stirred for 72 h. Removal of the solvent yielded solid MOF composite polymer 28 (194 mg).

### Example 29

### A PEMFC with the Composite Comprising Polymer 1 of Example 1 and Sulfuric Acid

A commercial catalyst ink of Pt/C and 5 wt % Nafion solution was painted onto two sides of the solid electrolyte membrane comprising polymer 1 and sulfuric acid (example 25). The Pt loading was 0.5 mg/cm² on both sides followed by hot pressing a carbon paper on each side at 150° C. under 120 psi for 10 min. The fuel cell test was carried out on a 5 cm² cell at the cell temperature of 60° C. under 100% RH with the flow rate of 60 mL/min of hydrogen and 10 mL/min of oxygen. The cell has a power density of 120 mW/cm² at 200 mA/cm². The cell was continuously run for over 200 h.

### Example 30

### Synthesis of the copolymer of tetrafluoroethylene and 8-{4-{1,1,2,2-tetrafluoro-2-[1,2,2-trifluoro-2-(1,2,2-trifluoroethenyloxy)-1-(trifluoromethyl)ethoxy]ethyl}benzyl}-1,5,8,11,14-pentazatricyclo[9.6.3.2^{5,14}]docosane (Polymer 30)

Nafion® NR50 beads or film (0.250 g) were refluxed under nitrogen in 2 mL thionyl chloride at 80° C. After 12 h, thionly chloride was removed by decanting. The polymer was washed with 10 mL×4 CH₂Cl₂ and dried under vacuum. The polymer was then introduced to an 8 mL aqueous solution of Na₂SO₃ (7.0 mmol) and NaHCO₃ (7.0 mmol) at 70° C. for 14 h. Then, the polymer was removed and washed with water 20 mL×3 and dried. The polymer was further introduced to the mixture of iodine (0.4 mmol) in EtOH (2 mL) and water (15 mL) at 60° C. After 3 h, the mixture was cooled down to ambient temperature. The polymer was removed by centrifuge and washed with EtOH (20 mL×3). Then, a mixture of this polymer, 8-benzyl-1,5,8,11,14-pentazatricyclo[9.6.3.2^{5,14}]docosane (1.25 mmol), trifluoroacetic acid (1.25 mmol) and t-butyl hydroperoxide (1.25 mmol) in DMSO (5 mL) was brought to 60° C. After 14 h, the solution was cooled down to ambient temperature. The solvent was removed and the polymer was thoroughly washed by CHCl₃ (20 mL×8). The copolymer was further purified using a Soxhlet extractor with methanol for 24 h to remove non-bonded impurities to yield polymer 30 as solid: ¹H NMR (400 MHz, DMSO-d6): δ 7.60-7.20 (m, 5H), 3.40 (s, 2H), 3.40-2.32 (m, 28H), 2.00-1.40 (m, 6H).

Polymer 30 (250 mg) was dissolved in 10 mL DMAc and poured into a 4.8 cm glass dish. The solvent was removed at 60° C. under vacuum for 12 h followed by at 120° C. under vacuum for two more h. The formed membrane was boiled in 1M LiOH solution for 1 h, washed with de-ionized water until neutral and then boiled in de-ionized water for 1 h. The ion conductivity of this membrane was found to be 9.6 mS/cm at 25° C. in de-ionized water.

### Example 31

### Synthesis of the copolymer of tetrafluoroethylene and 4-{4-{1,1,2,2-tetrafluoro-2-[1,2,2-trifluoro-2-(1,2,2-trifluoroethenyloxy)-1-(trifluoromethyl)ethoxy]ethyl}benzyl}-10,15-dioxa-1,4, 7-triazabicyclo[5.5.5]heptadecane (Polymer 31)

The same procedure used in example 30 was adopted except that 4-benzyl-10,15-dioxa-1,4,7-triazabicyclo[5.5.5]heptadecane was used to replace 8-benzyl-1,5,8,11,14-pentazatricyclo[9.6.3.2^{5,14}]docosane. Polymer 31 was obtained as solid (˜190 mg): ¹H NMR (400 MHz, DMSO-d6): δ 7.40-7.18 (5H, m), 3.62-3.08 (26H, m).

Polymer 31 (250 mg) was dissolved in 10 mL DMAc and poured into a 4.8 cm glass dish. The solvent was removed at 60° C. under vacuum for 12 h followed by at 120° C. under vacuum for two more h. The formed membrane was boiled in 1M LiOH solution for 1 h, washed with de-ionized water until neutral and then boiled in de-ionized water for 1 h. The ion conductivity of this membrane was found to be 7.8 mS/cm at 25° C. in de-ionized water.

### Example 32

### Synthesis of the copolymer of tetrafluoroethylene and 4-{4-{1,1,2,2-tetrafluoro-2-[1,2,2-trifluoro-2-(1,2,2-trifluoroethenyloxy)-1-(trifluoromethyl)ethoxy]ethyl}benzyl}-1,4, 7,10,15-pentazabicyclo[5.5.5]heptadecane (Polymer 32)

The same procedure used in example 30 was adopted except that 4-benzyl-1,4,7,10,15-pentazabicyclo[5.5.5]heptadecane was used to replace 8-benzyl-1,5,8,11,14-pentazatricyclo[9.6.3.2^{5,14}]docosane. Polymer 32 was obtained as solid: ¹H NMR (400 MHz, DMSO-d6): δ 7.42-7.06 (5H, m), 3.80-2.42 (26H, m).

Polymer 32 (250 mg) was dissolved in 10 mL DMAc and poured into a 4.8 cm glass dish. The solvent was removed at 60° C. under vacuum for 12 h followed by at 120° C. under vacuum for two more h. The formed membrane was boiled in 1M LiOH solution for 1 h, washed with de-ionized water until neutral and then boiled in de-ionized water for 1 h. The ion conductivity of this membrane was found to be 7.2 mS/cm at 25° C. in de-ionized water.

### Example 33

### Synthesis of the copolymer of tetrafluoroethylene and 3-{4-{1,1,2,2-tetrafluoro-2-[1,2,2-trifluoro-2-(1,2,2-trifluoroethenyloxy)-1-(trifluoromethyl)ethoxy]ethyl}benzyloxy}-1,5,9,13-tetrazatricyclo[7.7.3.3^{5,13}]docosane (Polymer 33)

The same procedure used in example 30 was adopted except that 3-benzyloxy-1,5,9,13-tetrazatricyclo[7.7.3.3^{5,13}]docosane was used to replace 8-benzyl-1,5,8,11,14-pentazatricyclo[9.6.3.2^{5,14}]docosane. Polymer 33 was obtained as solid: ¹H NMR (400 MHz, DMSO-d6): δ 7.52-7.20 (5H, m), 4.62-4.40 (3H, m), 3.92-3.60 (4H, m), 3.06-2.00 (20H, m), 2.00-1.40 (10H, m).

Polymer 33 (250 mg) was dissolved in 10 mL DMAc and poured into a 4.8 cm glass dish. The solvent was removed at 60° C. under vacuum for 12 h followed by at 120° C. under vacuum for two more h. The formed membrane was boiled in 0.5M NaOH solution for 1 h, washed with de-ionized water until neutral and then boiled in de-ionized water for 1 h. The ion conductivity of this membrane was found to be 11.0 mS/cm at 25° C. in de-ionized water.

1-33. (canceled)

34. A fluorocarbon polymer comprising a plurality of repeated units containing a triazole or tetrazole ring (RU(tria/tetra-zole)) of formula (I): 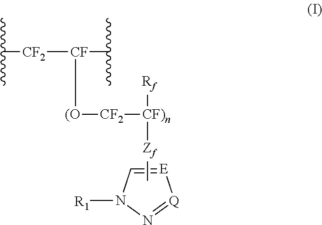
wherein:
wavy lines indicate the points of attachment to adjacent repeating units of the polymer; R_{f} is F or CF₃;
n is an integer number chosen from 1 or 2;
—Z_{f}— is a direct bond, —CF₂—, —CF₂CF₂—, or —OCF₂CF₂—;
E and Q are independently C—R₂ or N, provided that at least one of E or Q is N; and
R₁ and R₂ are independently H, SO₃H, NO₂, CN, a monovalent (C₁-C₆)hydrocarbon residue, a bivalent (C₁-C₆)hydrocarbon residue, a monovalent (C₁-C₆)fluorocarbon residue, or a bivalent (C₁-C₆)fluorocarbon residue, wherein two bivalent (C₁-C₆)hydrocarbon residues together can form a cycloalkyl or aromatic ring, or two bivalent (C₁-C₆)fluorocarbon residues together can form a cyclofluoroalkyl or a fluorinated aromatic ring.

35. The fluorocarbon polymer of claim 34, wherein R_{f} is F; n is 1; —Z_{f}— is a direct bond, —CF₂—, or —CF₂CF₂—; R₁ and R₂ are both H; and E and Q are either of the following: (a) E is N and Q is CH or (b) E is CH and Q is N.

36. The fluorocarbon polymer of claim 34, wherein R_{f} is CF₃; n is 1 or 2; —Z_{f}— is —OCF₂CF₂—; R₁ and R₂ are H; and E and Q are either of the following: (a) E is N and Q is CH or (b) E is CH and Q is N.

37. The fluorocarbon polymer of claim 34 further comprising random or sequentially placed repeated units of tetrafluoroethylene (RU(TFE)) of 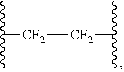
the fluorocarbon polymer having the structure of formula (II): 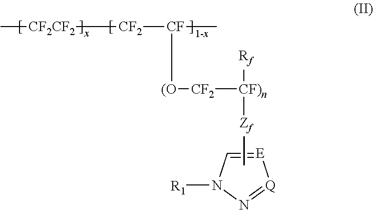
wherein:
x is a number ranging from 0 to 0.99 and represents the mole fraction of RU(TFE) in the fluorocarbon polymer; 1−x is a number ranging from 0.01 to 1.0 and represents the mole fraction of RU(tria/tetra-zole) in the fluorocarbon polymer;
R_{f} is F or CF₃;
n is an integer number chosen from 1 or 2;
—Z_{f}— is a direct bond, —CF₂—, —CF₂CF₂—, or —OCF₂CF₂—;
E and Q are chosen from C—R₂ and N, at least one of E and Q is N; and
R₁ and R₂ are independently H, SO₃H, NO₂, CN, a monovalent (C₁-C₆)hydrocarbon residue, a bivalent (C₁-C₆)hydrocarbon residue, a monovalent (C₁-C₆)fluorocarbon residue, or a bivalent (C₁-C₆)fluorocarbon residue, wherein two bivalent (C₁-C₆)hydrocarbon residues together can form a cycloalkyl or aromatic ring, or two bivalent (C₁-C₆)fluorocarbon residues together can form a cyclofluoroalkyl or a fluorinated aromatic ring.

38. The fluorocarbon polymer of claim 37, wherein R_{f} is F, n is 1; —Z_{f}— is a direct bond, —CF₂—, or —CF₂CF₂—; both R₁ and R₂ are H; E and Q are either of the following: (a) E is N and Q is CH or (b) E is CH and Q is N; and x ranges from 0.35 to 0.92.

39. A composite comprising the fluorocarbon polymer of claim 38 and H⁺_{n′}X^{n′-}, wherein n′ is an integer number chosen from 1, 2, 3, 4, or 5; X^{n′-} is a negatively charged anion; and the concentration of H⁺_{n′}X^{n′-} ranges from 4 to 70 wt % by weight of the composite.

40. The composite of claim 39, wherein H⁺_{n′}X^{n′-} is either H₂SO₄ or H₃PO₄; and the concentration of H⁺_{n′}X^{n′-} ranges from 4 to 20 wt % by weight of the composite.

41. The fluorocarbon polymer of claim 37, wherein R_{f} is CF₃; n is 1 or 2; —Z_{f}— is —OCF₂CF₂—; R₁ and R₂ are H; E and Q are either of the following: (a) E is N and Q is CH or (b) E is CH and Q is N; and x ranges from 0.65 to 0.92.

42. A composite comprising the fluorocarbon polymer of claim 41 and H⁺_{n′}X^{n′-}, wherein n′ is an integer number chosen from 1, 2, 3, 4, or 5; X^{n′-} is a negatively charged anion; and the concentration of H⁺_{n′}X^{n′-} ranges from 4 to 70 wt % by weight of the composite.

43. The composite of claim 42, wherein H⁺_{n′}X^{n′-} is H₂SO₄; n′ is 2; X^{n′-} is SO₄²⁻; and the concentration of H⁺_{n′}X^{n′} ranges from 4 to 20 wt % by weight of the composite.

44. The composite claim 42, wherein H⁺_{n′}X^{n′} is H₃PO₄; n′ is 3; X^{n′-} is PO₄³; and the concentration of H⁺_{n′}X^{n′-} ranges from 4 to 20 wt % by weight of the composite.

45. A fluorocarbon polymer comprising a plurality of repeated units containing an imidazole ring (RU(imidazole)) of formula (III), 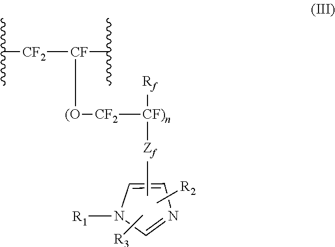
and random or sequentially placed repeated units of tetrafluoroethylene (RU(TFE)) of 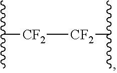
the fluorocarbon polymer having the structure of formula (IV): 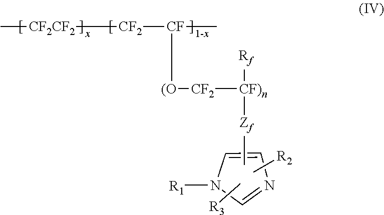
wherein:
x is a number from 0 to 0.99 and represents the mole fraction of RU(TFE) in the fluorocarbon polymer; 1−x is a number ranging from 0.01 to 1.0 and represents the mole fraction of RU(imidazole) in the fluorocarbon polymer;
R_{f} is F or CF₃;
n is an integer number of chosen from 1 or 2;
—Z_{f}— is selected from a group of a direct bond, —CF₂—, —CF₂CF₂—, and —OCF₂CF₂—; and
R₁ R₂, and R₃ are independently H, SO₃H, NO₂, CN, a monovalent (C₁-C₆)hydrocarbon residue, a bivalent (C₁-C₆)hydrocarbon residue, a monovalent (C₁-C₆)fluorocarbon residue, or a bivalent (C₁-C₆)fluorocarbon residue, wherein two bivalent (C₁-C₆)hydrocarbon residues together can form a cycloalkyl or aromatic ring, or two bivalent (C₁-C₆)fluorocarbon residues together can form a cyclofluoroalkyl or a fluorinated aromatic ring.

46. The fluorocarbon polymer of claim 45, wherein R_{f} is F; n is 1; —Z_{f}— is a direct bond, —CF₂—, or —CF₂CF₂—; R₁, R₂ and R₃ are H; and x ranges from 0.35 to 0.92.

47. The fluorocarbon polymer of claim 46, wherein —Z_{f}— is a direct bond; and x ranges from 0.65 to 0.92.

48. The fluorocarbon polymer of claim 45, wherein R_{f} is CF₃; n is 1 or 2; —Z_{f}— is —OCF₂CF₂—; R₁, R₂ and R₃ are H; and x ranges from 0.65 to 0.92.

49. A fluorocarbon polymer comprising a plurality of repeated units containing an aniline ring (RU(aniline)) of formula (V): 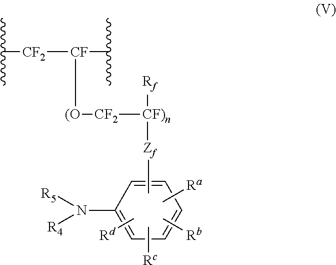
and random or sequentially placed repeated units of tetrafluoroethylene (RU(TFE)) of 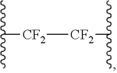
the fluorocarbon polymer having the structure of formula (VI): 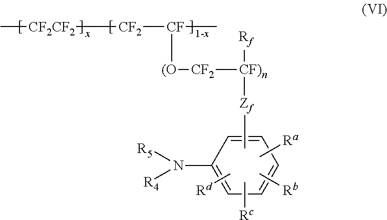
wherein:
x is a number from 0 to 0.99 and represents the mole fraction of RU(TFE) in the fluorocarbon polymer; 1−x is a number ranging from 1 to 0.01 and represents the mole fraction of RU(aniline) in the fluorocarbon polymer;
R_{f} is F or CF₃;
n is an integer number chosen from 1 or 2;
—Z_{f}— is a direct bond, —CF₂—, —CF₂CF₂—, or —OCF₂CF₂—;
R^{a}, R^{b}, R^{c} and R^{d} are independently H, F, SO₃H, NO₂, CN, a monovalent (C₁-C₆)hydrocarbon residue, a bivalent (C₁-C₆)hydrocarbon residue, a monovalent (C₁-C₆)fluorocarbon residue, or a bivalent (C₁-C₆)fluorocarbon residue, wherein two bivalent (C₁-C₆)hydrocarbon residues together can form a cycloalkyl or aromatic ring, or two bivalent (C₁-C₆)fluorocarbon residues together can form a cyclofluoroalkyl or a fluorinated aromatic ring; and
R₄ and R₅ are independently H, R′, C(O)R′, S(O)R′, or S(O)₂R′, wherein R′ is a monovalent (C₁-C₆)hydrocarbon residue or a bivalent (C₁-C₆)hydrocarbon residue, wherein two bivalent (C₁-C₆)hydrocarbon residues together can form a cycloalkyl or aromatic ring.

50. The fluorocarbon polymer of claim 49, wherein R_{f} is F; n is 1; —Z_{f}— is a direct bond; R^{a}, R^{b}, R^{c} and R^{d} are independently H, F, or CF₃; R₄ and R₅ are H; and x ranges from 0.65 to 0.92.

51. The fluorocarbon polymer of claim 49, wherein R_{f} is CF₃, n is 1 or 2, —Z_{f}— is —OCF₂CF₂—, R^{a}, R^{b}, R^{c} and R^{d} are independently H, F, or CF₃, R₄ and R₅ are H; and x ranges from 0.65 to 0.92.

52. A composite comprising the fluorocarbon polymer of claim 49, H⁺_{n′}X^{n′-}, and an optional support, wherein n′ is an integer number chosen from 1, 2, 3, 4, or 5; X^{n′-} is a negatively charged anion, and the concentration of H⁺_{n′}X^{n′-} ranges from 4 to 70 wt % by weight of the composite.

53. The composite of claim 52, wherein H⁺_{n′}X^{n′-} is either H₂SO₄ or H₃PO₄; and the concentration of H⁺_{n′}X^{n′-} ranges from 4 to 20 wt % by weight of the composite; and the optional support is a poly(tetrafluoroethylene) film having a thickness ranging from 20 to 180 microns and a density ranging from 0.3 g/cm³ to 1.0 g/cm³.
